(19) United States
(12) Patent Application Publication
(10) Pub. No.: US 2010/0114783 A1
(43) Pub. Date: May 6, 2010

(54) System for combining and bundling commercial products, items having monetary value, business transactions, and entertainment

(76) Inventor: Margaret M. Spolar, Montrose, PA (US)

Correspondence Address: Mark Levy;HINMAN, HOWARD & KATTELL, LLP, 80 Exchange Street, P.O. Box 5250, BINGHAMTON, NY, 13901, US

(21) Appl. No.: 12/319,506

(22) Filed: Jan. 7, 2009

Related U.S. Application Data
(63) Continuation-in-part of application No. 12/156,974, filed on Jun. 6, 2008.
Application No. 12/156,974 is a continuation-in-part of application No. 11/985,393, filed on Nov. 15, 2007.
(60) Provisional application No. 60/872,860, filed on Dec. 5, 2006.
(60) Provisional application No. 61/065,521, filed on Feb. 13, 2008.

(51) Int. Cl. G06Q 30/00; G06Q 50/00

(52) U.S. Cl. 705/80; 705/26

(57) ABSTRACT

A method for acquiring and distributing entertainment items, information representative of monetary funds, and/or commercial products, some or all which maybe combined or bundled in a single package. Goods and services are first identified. Advertising is provided for at least one commercial product. The advertising includes a predetermined code associated with the commercial product. The commercial product is sold and, upon acceptance of the predetermined code, a second commercial product or an entertainment item or a medium containing information representative of monetary funds is provided as a single entity or transaction.

### RELATED PATENT APPLICATIONS

The present patent application is a continuation-in-part of copending U.S. patent application Ser. No. 12/156,974, filed Jun. 6, 2008, which was a continuation-in-part of copending U.S. patent application Ser. No. 11/985,393, filed Nov. 15, 2007 for ENTERTAINMENT, BUSINESS TRANSACTIONS, INFORMATION, TELECOMMUNICATIONS INTERNET PACKAGE, which was a continuation-in-part of U.S. provisional patent application Ser. No. 60/872,860, filed Dec. 5, 2006, for ENTERTAINMENT, BUSINESS TRANSACTIONS, INFORMATION, TELECOMMUNICATIONS PACKAGE; and of copending U.S. provisional patent application Ser. No. 61/065,521, filed Feb. 13, 2008, all of which are hereby incorporated by reference.

### FIELD OF THE INVENTION

The invention pertains to methods and apparatus for distributing advertisements, promotions, advertising materials, information and business transactions, event flyers, tickets, stickers, label tags, register receipts, posters, newspapers, emails, logos, web banners, hand outs, Internet, social, networks MySpace, Facebook, word-of-mouth, pop-ups, and the like, with one or more commercial products, entertainment, items having monetary value, downloads, phone cards, gift cards, VISA cards, and the like, and more particularly, to a system that combines or bundles advertisement material with such products, as part of the same transaction.

### BACKGROUND OF THE INVENTION

Paper products such as postcards, flyers, advertisements, stickers, newspapers, event tickets, promotions, magazines, register receipts, napkins, label tags, ads, tickets for sport-related events, printouts on Internet, movie tickets, posters and such are used everyday. Corporations and businesses along with retailers spend millions of dollars on paper products to promote commercial items, entertainment, events, and the like. Once a consumer reads an ad, a flyer, a newspaper or pays for a ticket at an event, or uses a sticker on an article, the paper product no longer has a use. Many times these paper products are tossed to the curb or thrown into trashcans and shipped off by garbage trucks. Paper products and memorabilia are distributed worldwide including printouts on Internet in large quantities and would be better served if they had a second purpose.

Advertising spending has increased dramatically in recent years. In 2006, spending on advertising has been estimated at $155 billion in the United States and $385 billion worldwide, the latter to exceed $500 billion by 2010. Television and radio station owners earn more money by selling sponsorship rights in small time allocations to multiple businesses throughout their radio station and television broadcasts.

While advertising can be necessary for economic growth, it is not without social costs. Unsolicited commercial email “spam” have become so prevalent that they are a major nuisance to users of these services, as well as being a financial burden on internet service providers. Advertising is increasingly invading public spaces, such as schools, colleges, and corporations.

Another advertising approach is producing unexpected messages that made advertisements more tempting to consumers' eyes and ears. Ad campaigns which feature such headlines as “unique” or “power” are designed to associate each brand with a specific idea in the reader's or viewer's mind. The system helps the participating retailers, merchants, distributors, and manufacturing companies learn what is hot and what is not: trends, styles, choices, clubs, organizations, likes and dislikes.

Advertisements are often placed anywhere an audience can easily or frequently access visual, audio and printed information. Advertisements can be seen on the seats of shopping carts, on the walls of an airport walkways, on the sides of buses, and are heard in telephone hold messages and in-store public address systems. Organizations often spend large sums of money on advertising that sells what is not, strictly speaking, a product or service, such as for promoting political parties, interest groups, religious organizations, and military recruiters.

Commercial advertising media can include wall paintings, billboards, street furniture components, printed flyers and rack cards, radio, cinema and television ads, web banners, mobile telephone screens, shopping carts, web pop-ups, skywriting, bus stop benches, human directional, magazines, newspapers, town criers, sides of buses or airplanes (“logojets”), in-flight advertisements on seatback tray tables or overhead storage bins, taxicab doors, roof mounts and passenger screens, musical stage shows, subway platforms and trains, elastic bands on disposable diapers, stickers on apples in supermarkets, shopping cart handles, the opening section of streaming audio and video, posters, and the backs of event tickets and supermarket receipts.

Some companies have even proposed to place messages or corporate logos on the side of booster rockets and the International Space Station. Any place where a sponsor delivers its message through a medium is advertising or advertisement broadcast, sent out to the public to make it aware of products, events, and the like.

Marketing through the Internet for advertising contributes to corporations operated solely on advertising revenue, offering everything from coupons to free Internet access. Websites, including the search engine Google, changed online advertising by emphasizing contextually relevant, unobtrusive ads intended to help, rather than inundate, users. This led to a plethora of similar efforts and an increasing trend of interactive advertising.

“Guerrilla promotions” involves unusual approaches such as staged encounters in public places, giveaways of products such as cars that are covered with brand messages, and interactive advertising where the viewer can respond to become part of the advertising message. This has reflected an increasing trend of interactive and “embedded” ads, such as via product placement, having consumers vote through text messages, and various innovations utilizing social networking sites (e.g., MySpace).

Mobile billboards are truck- or blimp-mounted billboards or digital screens. These can be dedicated vehicles built solely for carrying advertisements along routes preselected by clients, or they can be specially-equipped cargo trucks. The billboards are often lighted; some being backlit, and others employing spotlights. Some billboard displays are static, while others change; for example, continuously or periodically rotating among a set of advertisements.

Public service advertisements are used to promote commercial goods and services and can be used to inform, educate and motivate the public about non-commercial issues. Public service advertising, non-commercial advertising, public interest advertising, cause marketing, and social marketing are different terms for the use of advertising and marketing communications techniques (generally associated with commercial enterprise) on behalf of non-commercial, public interest issues and initiatives. In the United States, the granting of television and radio licenses by the FCC is contingent upon the station broadcasting a certain amount of public service advertising. To meet these requirements, many broadcast stations in America air the bulk of their required public service announcements during the late night or early morning when the smallest percentage of viewers is watching, leaving more day and prime time commercial slots available for high-paying advertisers. Non-profit organizations are not typical advertising clients, and may rely on free modes of persuasion, such as public service announcements.

Another way to measure advertising effectiveness is known as ad tracking. This advertising research methodology measures shifts in target market perceptions about the brand and product or service. These shifts in perception are plotted against the consumers' levels of exposure to the company's advertisements and promotions. The purpose of Ad Tracking is generally to provide a measure of the combined effect of the media weight or spending level. Another advertising method is covert advertising, when a product or brand is embedded in media and entertainment.

A TV commercial is generally considered the most effective mass-market advertising format, as is reflected by the high prices TV networks charge for commercial airtime during popular TV events. The annual Super Bowl football game in the United States is known as the most prominent advertising event on television. The average cost of a single thirty-second TV spot during this game has reached $2.7 million as of 2007. The majority of television commercials features a song or jingle that listeners soon relate to the product. Virtual advertisements may be inserted into regular television programming through computer graphics, typically inserted into otherwise blank backdrops or used to replace local billboards that are not relevant to the remote broadcast audience. More controversially, virtual billboards may be inserted into the background where none exist in real-life. Virtual product placement is also possible. Infomercials are also known as direct response television (DRTV) commercials. The main objective in an infomercial is to create an impulse purchase, so that the consumer sees the presentation and then immediately buys the product through the advertised toll-free telephone number or website.

Increasingly, other media are overtaking television because of a shift towards consumer's usage of the Internet as well as devices such as TiVo. Advertising on the world wide web is a recent phenomenon. Prices of web-based advertising space are dependent on the relevance of the surrounding web content and the traffic that the website receives. email advertising is another recent phenomenon.

Social networking and advertising is another way of advertising. Unpaid advertising (also called word-of-mouth advertising) can provide good exposure at minimal cost. Personal recommendations such as “bring a friend” or “sell it” or “spread the buzz” can achieve advertising. Mobile phone ads, downloadable content, banners, coupons, MMS pictures and video messaging, advergames, games, coupons, the web, and other marketing campaigns target consumers. Likewise cell cameras can send ads and cells also can immediate receive an ad on the through web on modern phones. There are also short programming breaks aired by “The CW” called content wraps.

As used hereinbelow, the word “content” includes advertising, social networking, passwords, codes, words, phrases, commercial products, items having monetary value, entertainment items, business transactions, and information.

Commercial products or items and entertainment content are used every day. In fact, a high percentage of the consumer fee for entertainment content such as DVDs and CDs, whether used to hold music, movies, games, data or computer software for example, is for the purchase of these products. Likewise commercial products such as, but not limited to, food items, consumer electronics, electrical products, hardware, automotive and accessories therefor, textile items, toys, sporting goods, specialty items, specialty services, stationery, crafts, books, magazines, memorabilia of all sorts, footwear, health and beauty items, collectibles, home and garden, jewelry, linens, clothing, pottery, glassware, computers, and computer products, computer services, gift certificates, gift cards, cameras, art, antiques, and the like, phone cards, credit cards, debit cards, and entertainment products, are used on a daily basis and distributed in large quantities usually in a reliable, inexpensive package.

Many products, services, and information can be purchased on retail shelves or accessed for purchase via the Internet. The consumer searches the best way to shop. Whether the consumer shops using retail or Internet, he is usually in search of an easier way in which to complete purchases.

There are many types of cashier computers, also known as system computers or computer checkout stations, to handle monetary transactions, including but not limited to point-of-sale (POS) systems, First Data, retail management systems, Microsoft Dynamics, cash tellers, Sharp, Casio, Palm Pilot, BarCode Scanners, IBM retailer, and Samsung. They all have similar functions: to compute exact change, simplify the cashier's role, involve the packing patron, track every thing, prepare audit data, and provide reports. A cashier computer is set up to minimize leakage and track every penny that is due. The cashier computer works the pricing, sales, and promotions. It handles inventory and payment processing. Point-of-sale (POS) systems replace standalone cash registers with computer-based sales software. A POS system may include a touch screen, scanner, or keyboard for inputting prices, as well as a display and a computer. By helping track inventory, they reduce “shrinkage” and employee theft. Automatic price tracking improves price accuracy over traditional cash registers.

Nielsen's consumer packaged goods (CPG) research shows that while shopping frequency across most retail supercenters, which enable consumers to combine shopping trips with more items in one store, continues to show growth. Alternative channels, including hardware/home improvement stores, office supply stores, automobile supply stores and bookstores are increasing the level of competition for traditional retailers and increasing the distribution opportunities for manufacturers.

Certain applications blur the distinction between entertainment content and commercial products, such as Blackberry service, Wi-Fi, Yahoo, satellite radio, San Disk memory cards, subscription services, broadband Internet service, cable TV, direct TV, DMX digital music, iPhone, Sansa Connect music players, and electronic devices.

Retail stores represent a friendly way for consumers to shop in a more personal way, in which the consumer can see and touch the product before he purchases it. The consumer can view the difference between other products and read labels more closely. The retail store develops a relationship with consumers, whereas the seller understands through its service what customers expect.

Retail purchases are made by way of cash, visa, ATM, debit, gift cards, and the like. Electronic data capture (EDC) magstripe-card swipe terminals have become ubiquitous, requesting the user to swipe his own card at the checkout station.

A credit card is a thin plastic card, usually 3-⅛ inches by 2-⅛ inches in size, which contains identification information such as a signature or picture, and authorizes the person named on it to charge purchases or services to his account, charges for which he is billed periodically. Under the plan, the bank credits the account of the merchant as sales slips are received and assembles charges to be billed to the cardholder at the end of the billing period. The cardholder, in turn, pays the bank either the entire balance or in monthly installments with interest.

Separate distribution of products typically has no advantage for the consumer. For years, music on CD, mini-CD, or DVD, books on DVD, movies on DVD, events on DVD, sports on DVD, exercise programs on DVD, stand up comedy on DVD, magicians on DVD, cooking on DVD, history on DVD, the Bible on DVD, educational programming on DVD, training programming on DVD, drivers training on DVD, gardening on DVD, health on DVD, dance on DVD, concerts on DVD, magic shows on DVD, yoga on DVD, computer games, Game Boy Advance, Nintendo DS, Nintendo GameCube, Nintendo WII, Xbox, Play Station 2, Play Station 3, PSP, and the like have been sold separately.

The Internet, as opposed to brick-and-mortar retail sales, has created a new set of connections between buyers and sellers and offers other possibilities for creating opportunities for businesses to deal with customers. Moreover, the Internet is a medium that can excite customer interest, can close sales quickly and conveniently, and can do so cost-effectively. It enables a customer to pay for goods or services by using credit cards.

Internet payment processing involves transactions over an open Internet connection, so the transaction can be performed online, potentially even on a web server itself. Internet transaction services typically provide an application programming interface (API), which is an HTML-type input terminal for manual entry and full online reports of transactions and batches thereof. Transaction processors are separate from the banks that provide a merchant account, although some providers provide a single transaction statement, seemingly providing a single service.

To avail himself of these services, a consumer must have a computer, he must be connected to the Internet, and he must use a web browser. The consumer must visit a web site to find the item that best services his needs. Once the consumer decides to make a purchase, the web pages show the consumer how to place an order and to pay for the product or service.

If the consumer chooses to use a credit card, he must key his credit card details into a web form. Those details include the type of card (e.g., Bankcard, MasterCard, or Visa), the credit card number, the card's expiry date, and the name as displayed thereon. The Internet Service Provider (ISP) receives those details across the Internet or, when purchasing at a retail store, at the counter.

Internet merchant accounts are separate bank accounts that are capable of receiving credit card payments from credit card providers. Internet merchant accounts typically do not hold funds for an extended period of time such a typical bank account, but usually transfer payments to another bank account designated by the Internet merchant on a daily basis.

The payment gateway account is the online credit card processor or transaction handler that is capable of hooking into credit card accounts belonging to the online consumer and the merchant's Internet merchant account. The payment gateway handles the verification and transfers requests. The term account when used with payment gateway is not the funds holding account but rather a service account that typically has a log in which configures the payment gateway settings.

Merchant services providers set number up merchant accounts and a Gateway Credit. Merchant accounts are bank accounts specifically designed to accept and transfer credit card funds via the credit card processing network. Cards are processed through an Internet merchant account either manually through an in-store credit card terminal, online through a web based terminal page, or automatically through an associated payment gateway provider linking to the merchant's web shopping cart.

Three primary components are part of the standard merchant account fee structure:
One time fees
Recurring monthly fees
Transaction related fees
per transaction (set fee such as 30 cents)
per order totals (percentage fee such as 2.35%)

These same items apply to the payment gateway fee structure:
One time fees
Recurring monthly fees
Transaction fees

A third party payer merchant account alternative payment method such as PayPal can be used. In this payment method, Internet purchases are charged as if the third party payment service is the seller. Though the actual merchant sets up the store with products and pricing. The third party processor is technically the seller. The actual merchant then becomes a supplier and drop shipper.

Ecommerce or a gateway like USA Payment secures Internet payment processing. A merchant account, sometimes referred to as Internet/MoTo account, is needed. Merchant account companies act as a middleman between the merchant and the credit card provider and determines whether the applicant meets the provider's requirements.

Entertainment products store data such as text, graphics, photo, audio or video files. The consumer may chose his entertainment products in physical form, such as on a CD, a DVD, a ROM, a hardware device, an electronic device, and any other suitable medium.

Downloading files from the Internet is usually a straightforward process. The term “download,” however, can also be used as a noun, typically representing music or video files. The first step is saving the file to the user's drive on his local system. Downloaded files are typically in compressed or encoded format such as ZIP (Windows) or SIT (Macintosh) or Binhex (HQX). Encoding files ensures more reliable data transfer. Encoded files must first be decoded before they can be accessed. Decompression software such as WinZip or Stuffit expander can be used to open or extract these types of files. On some browsers, the folder in which the file is to be stored is a preference set in the decompression software using compressed files. Binhex, binary or MacBinary (BIN) files are common ways of encoding files for transmission over the Internet.

Downloading is also possible using MP3 files from the Internet to their content on a computer, listening to them on a portable MP3 player, or burning them to CDs. The MP3 format makes song files small enough to move around on the Internet in a reasonable amount of time.

Napster represents a different way to distribute MP3 files. Instead of storing the songs on a central computer, the songs reside on individual users' machines. Downloading a song using Napster is actually downloading the song from another person's machine.

BlueRay, also known as BlueRay Disc (BD), is the name of a next-generation optical disc format developed by the BlueRay Disc Association. The format was developed to enable recording, rewriting and playback of high-definition video (HD), as well as storing large amounts of data. The format offers more than five times the storage capacity of traditional DVDs and can hold up to 25 GB on a single-layer disc and 50 GB on a dual-layer disc. This extra capacity combined with the use of advanced video and audio offers consumers an unprecedented HD experience. While current optical disc technologies such as DVD, DVD±R, DVD±RW, and DVD-RAM rely on a red laser to read and write data, the new format uses a blue-violet laser instead, hence the name BlueRay. Despite the different type of lasers used, BlueRay products can easily be made backwards compatible with CDs and DVDs through the use of a BD/DVD/CD compatible optical pickup unit.

There are many ways to process and to hold information, such as computers, databases, systems, memory, Internet connections, hardware, and the like. Databases can contain information to allow tracking of items and transactions based on conditions, functions, attributes, labels, characters, and systems. One kind of database is that which is used as a structured collection of records or data which can be organized or categorized to structure, model, or support a model. Network models tend to store records with links to other records. The Internet can act as a model to store transaction data. An online database is a database accessible through the Internet and, as such differs from a local database held in an individual computer, system, or its attached storage, such as a CD or DVD.

Promotional schemes have existed since the first products and items were offered for sale. Nowadays, it is not unusual to find that a product, such as a printer, may have a coupon associated therewith. Once the user buys the printer, he can redeem a coupon to receive a toner cartridge by mailing his coupon or communicating the information thereon via telephone or email. Moreover, certain goods and services are packaged with information regarding rewards. For example, the purchase of an airline ticket may qualify the user to redeem gifts based on the number of miles represented by the ticket sale.

All of these incentives require delayed gratification on the part of the consumer, who must take one or more separate steps to redeem the coupon or rewards for his benefit. In this age of instant gratification, however, the value of incentives is diminished with the effort required for the customer to take advantage thereof. In other words, the extra steps in redeeming a coupon or rewards act as impediments or obstacles to the incentive program.

What is needed is a system for encouraging customers to utilize paper products more than once and/or social advertising, including but not limited to word-of-mouth advertising. A consumer would find gratification if he could go to an event (e.g., sports event, religious event, entertainment event, educational event, retail sales event, food event, a carnival, amusement parks, tours, etc.) or enter an establishment (e.g., a retail store, a club, a school, a college, a barber shop, a gas station, a restaurant, a church, a movie theater, and the like) and be able to obtain a product. He can have the product activated by applying money to paper product, a promotional advertisement, a ticket, a flyer, a poster, word-of-mouth, a social network, and the like. When activated, the paper product would allow the consumer to receive one or more products such as commercial items, entertainment products, information and business transactions, items having monetary value, and the like, using a system, or method, details of which are provided hereinbelow. The system delivers immediate satisfaction for the customer and eliminates extra procedures and equipment on the part of the customer to cash in on the incentives. The system offers a more efficient way to track millions of consumers actions, trends, styles, likes and dislikes.

### SUMMARY OF THE INVENTION

In accordance with the present invention, there is provided a method for acquiring and distributing at least one or two commercial products, items having monetary value, business transactions, entertainment, or information, in a single combined or bundled transaction. Goods and services are first identified. Advertisement is provided from at least one event, retail store, club, food event, concert, sport event, enbedded in sound, social network, phrase, commercial product, and the like. The advertisement includes a predetermined serial number associated with the combined or bundled system. The system allows the user to use a method, or to use an application, or to use a specification, which activates advertisement and allow a single transaction to take place. The advertisement content is used to activate the system which combines and bundles, one or more commercial product, items of monetary value, business transaction, entertainment, or information, upon acceptance of the predetermined serial number, as a single entity or transaction. A mechanism is also provided for qualifying a customer to participate in a contest.

### BRIEF DESCRIPTION OF THE DRAWINGS

A complete understanding of the present invention may be obtained by reference to the accompanying drawings, when considered in conjunction with the subsequent detailed description, in which:

FIG. 1a is a schematic view of a package in accordance with the invention, showing a telecommunication medium and an entertainment medium;

FIG. 1b is a schematic view of the reverse side of the package shown in FIG. 1a;

FIG. 2 is a flow chart of user operations in utilizing a telecommunications media (e.g., a telephone card);

FIG. 3 is a flow chart of manufacturer/distribution operations in acquiring and distributing entertainment content and telecommunications time;

FIG. 4 is a flow chart depicting user operations in participating in a contest relating to the inventive package;

FIG. 5 is a block diagram showing data flow from point of purchase to credit card and then to delivery;

FIG. 6 is a flow chart of user operations in utilizing a telecommunications media (e.g., a telephone card);

FIG. 7 is a flow chart of manufacturer/distribution operations in acquiring and distributing entertainment content and an item representative of monetary value;

FIG. 8 is a flow chart depicting user operations in participating in a contest relating to the inventive package;

FIG. 9 is a block diagram depicting Internet-based transaction of a consumer purchasing goods or services using a credit card;

FIG. 10 is a block diagram showing flow from point of purchase of a commercial item through the consumer and thence to the medium containing entertainment content;

FIG. 11 is a flow chart of manufacturer/distribution operations in acquiring and distributing entertainment content and selling the commercial item;

FIG. 12 is a flow chart of merchant operations for commercial items purchased over the Internet;

FIG. 13 is a flow chart depicting user operations in participating in a contest relating to the inventive entity;

FIGS. 14a and 14b, taken together, depict the front and obverse faces of a postcard used as a handout in accordance with the present invention;

FIG. 15 is a block diagram showing the system for allowing a customer to use bundles of similar or disparate goods and/or services;

FIG. 16 is a flow chart of manufacturer/distribution operations in acquiring and distributing entertainment content and selling bundles of commercial items; and

FIG. 17 is a flow chart of user operations in purchasing goods or services at a retail establishment and redeeming them via the Internet or at a physical location.

### DETAILED DESCRIPTION OF THE PREFERRED EMBODIMENT

The system enables the user to deal with advertising material, information, advertisements, and promotional items, with greater efficiency and certainty. The system allows the user to use a method, or to use an application, or to use a specification to activate advertisements, advertising materials, information, and promotional material, with a specified purchase of one or more items that include content. The system combines items or bundles multiple items such as, commercial products, items having monetary value, business transactions, entertainment items, information, as a single purchase.

The invention is a single entity for providing entertainment content with the purchase of a commercial product or monetary value item. A first medium holds the entertainment content, and the commercial item can be any product sold at a retail store or on the Internet. Commercial items or products may be, for example, foods, clothing, toys, health and beauty products, home and garden products, jewelry, linens, automotive, etc. Entertainment content is also storable on commercial products and may reside on such items as CDs, DVDs, games, electronic devices, downloadable files representative thereof, media that includes information representative of monetary funds, etc.

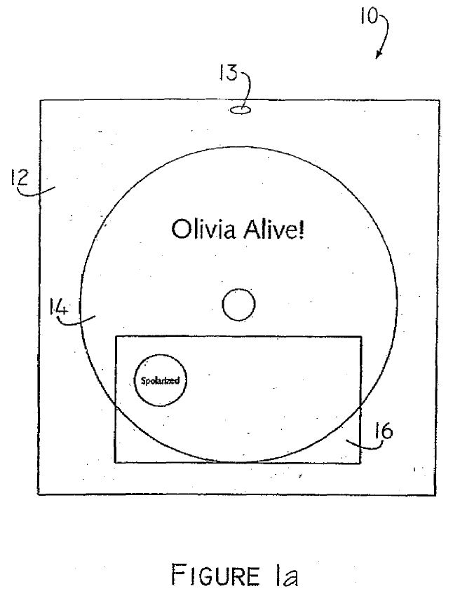

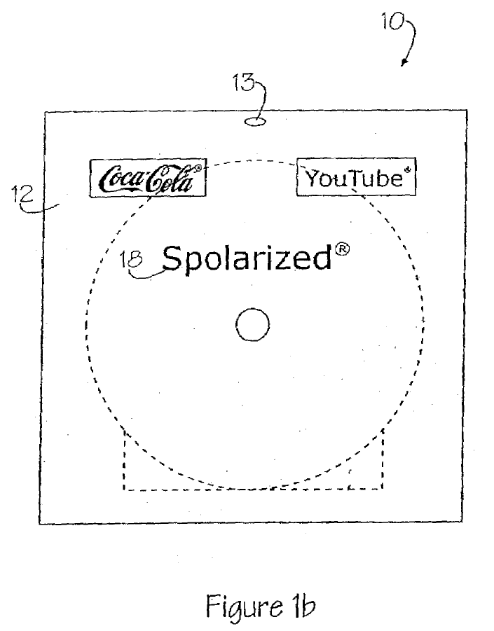

Referring now to FIGS. 1a and 1b, there is shown generally at reference number 10 a combination package or collection. A cardboard, laminated cardboard or plastic substrate 12 has an aperture 13 for hanging on a store display rack, not shown. Substrate 12 may be any suitable material for carrying out its function. Written material, such as the advertisement for a Spolarized® product, for example shown as reference number 18, can be printed on either or both front and rear sides of substrate 12. The written material may be used for advertising products of other manufacturers or vendors. Entertainment media in the form of a CD, mini-CD or DVD 14 is attached and carried by the substrate 12. CDs and DVDs can be produced in any of a number of formats such as rewritable CD-R, DVD+R, high density, etc. It should be understood that other forms of the entertainment media such as, but not limited to entertainment cards (i.e., a card representative of monetary funds for entertainment content), can be provided, as desired, without departing from the scope of the invention. Since entertainment includes providing amusement (events, performances, recreational activities) to at least one person, other forms of the entertainment media include but are not limited to digital files residing on electronic devices such as memory sticks, non-volatile memory cards, MP3 players, optical storage disks, multimedia cards, SanDisk, Apple iPods, solid state devices (ROMs), Bluetooth handsets, Blackberry devices, HP iPAQ, Palm, Zune to Zune, iFlops, MP3 pillows, Virgin Mobile, Slice, Zen Micro Photo MP3, T-Mobile, cellular telephones, Xbox, Nintendo WII, Nintendo DS, Nintendo GameCube, Gameboy, computer games, PSP, Play Station, TracFone, Chocolate, INpulse, Firefly, U3 Data Traveler, Digital MP3 WMA, ZenV, Walkman, MP3 FM tuner, iMovie, Boom Box, iPod Nano, iPod Talking Shoe, Audiovox Xpress, Micro SD, XM card, satellite radio digital music, Flicker Photos, mobile prepaid plan cards, pay-as-you-go wireless, Internet service cards, laptop cards, mobile phone cards, landline telephones, cellular phones, Virgin Mobile, Slice, iPhone, Bluetooth, camera phones, Motorola RAZR, NeXus satellite radio, MP3/DVD/CD/WMA receiver iPod and XM-ready, Ticketmaster, band credit cards, debit cards, ATM cards, Internet service, gift card, membership card, rewards card, promotion card, celebrity card, ring tones, photo card, merchandise cards, entertainment cards, Amp'd card, promotional cards, wireless gift card, YouTube, Kiosk, music downloads, movie downloads, parents cards, points cards, electronic video cards, Free Leader, GPhone, mobile caller, itune7, PDA's, Trac-Fone, WIFI, BlueRay, mobile web and email, SanDisk Sansa, CB radio, walkie-talkie, digital cable, HBO Cinemax, DVR service, boost mobile, Xing tone software, Broadband cards, cash and non-cash rewards, Travel & Entertainment cards (T&E), house cards, Napster, Mobile TV, air travel cards, Sunnysoft calling cards, cards, Pennytalk, Microsoft Max, Photo MP3, Corel Snapfire, cash and non-cash rewards, points cards, satellite radio digital music, Internet-based applications, including Flicker Photos, iPhone, T-Mobile, STI mobile, Net10, Edge and WIFI laptop PC cards (T-Mobile), Smartphones, Express cards, T-Mobile to Go, Text messaging, Java Games, WAV/AAC/AACT music players, walkman, PC card, USB modem, video share calling, micro SD, mini SD, Media players, MMS, QuickShare, messaging packing MSN,YAHOO, AOL, ICQ, AIM, Billboards, multimedia messaging, data download speed burst, upload burst, 2way SMA, dual band, Quad-Band(GPRS/EDGE) worldwide communication, instant messenger, social networks, Facebook, MySpace, Edge technology high speed data, Yahoo Messenger, and the like.

The separate distribution of each product typically has no advantage for the consumer. For years, music on CD, mini-CD, or DVD, books on DVD, movies on DVD, events on DVD, sports on DVD, exercise programs on DVD, stand up comedy on DVD, magicians on DVD, cooking on DVD, history on DVD, the Bible on DVD, educational programming on DVD, training programming on DVD, drivers training on DVD, gardening on DVD, health on DVD, dance on DVD, concerts on DVD, magic shows on DVD, yoga on DVD, computer games, Game Boy Advance, Nintendo DS, Nintendo GameCube, Nintendo WII, Xbox, Play Station 2, Play Station 3, PSP, and the like have been sold separately.

A registration serial number, not shown, is embedded in the entertainment media 14 and optionally printed on substrate 12 and/or on a label therefore, Advertising can also be printed on media labels. The serial number is discussed in greater detail below. Moreover, printed material, such as advertising 18 (FIG. 1b) can be printed on entertainment media 14. Such printed material 18 can likewise be disposed on the face and/or obverse of entertainment media 14. Moreover, advertising in the form of sound and/or images can be embedded before, during or after the content stored on the entertainment media 14, itself, for play or display to the user.

Telecommunication media in the form of a plastic or other suitable physical card 16 is attached and carried by the substrate 12. It should be understood that other telecommunications media can be provided, as desired, without departing from the scope of the invention. In the preferred embodiment, plastic card 16 has a magnetic strip, not shown, attached to one surface thereof. The strip includes digital information representative of the number of telephone calling minutes purchased. In applying the magnetic strip, a suitable machine prints the card 16. The card 16 then is fed to a different machine that glues the strip not shown or a static bar to the card 16. The card 16 is then sent to a different machine that codes the bar. The magnetic strip is a thin layer of magnetizable material that is placed on conventional or rechargeable (PINGO) phone cards, iPhone cards, land line telephone cards, smart cards with embedded IC chip(s), credit cards, targeted credit cards (gas cards, store cards, student cards, parent cards, teen credit cards, etc.) bank ATM cards, debit cards, no-fee cards, gift cards, international phone cards, prepaid phone cards, pay as you go cards, money cards, travel cards, monetary fund cards, club cards, dinner cards, mobile phone memory cards, mobile prepaid plan cards, Internet service cards, and laptop cards, mobile phone cards, cellular phones, T-mobile, Virgin Mobile, Slice, Bluetooth, Zune to Zune, iFlops, camera phones, Motorola RAZR, NeXus satellite radio, iPhone, MP3/DVD/CD/WMA receiver iPod and XM-ready, Ticketmaster, band credits cards, debit cards, ATM cards, Internet service, membership cards, rewards cards, promotional cards, celebrity cards, ring tones, photo cards, merchandise cards, iTune cards, eMusic cards, entertainment cards, cards, music download, free loader, parents load, electronic video games, Kiosks cards, mobile tracker, cash and non-cash cards, walkie talkie, Mobile TV, WIFI, TracFone, ring tones, GPhone, cardless calling cards, Internet-based applications, QAV/AAC/AACT music player, and wireless gift cards.

The strip is a plastic material with magnetizable powder mixed in with it. The strip can be magnetized by exposing it to a strong magnetic field. Bits of the composition can be magnetized in different directions by a device that generates a strong magnetic field over a short distance. The strip can have many North and South poles on it. The numbers and locations of the poles are used to encode information.

The strip is read with a similar (or even the same) device that wrote it. The process also works in reverse. By moving the strip back and forth over a read head, voltages are induced in coils that can be amplified and recorded electronically, so that information can be sent to a computer. The PIN may activate through a mag strip, a bar code, etc., depending on which system and/or database terminal has been set up by the retail store to read PIN numbers. When the user purchases a phone card 16 at a register, the data are sent through the system that is in place with that retailer. The information is then sent to the carrier's central terminal to inform the carrier that the sale took place. The carrier then activates the PIN and sends a data wave to the partner.

As aforementioned, printed material such as advertising can be printed on either or both sides of substrate 12 on entertainment media 14, as well as on calling card/credit card, debit card, gift card, etc. 16.

Certain applications blur the distinction between entertainment and telecommunications, such as Blackberry service, WiFi, Yahoo, satellite radio (Sirius), San Disk memory cards, subscription services, broadband Internet service DMX digital music, iPhone, entertainment services and subscriptions, downloadable music, movies, games, and the like, phone service providers, cable networks, social networks, shared music, and Sansa Connect music players.

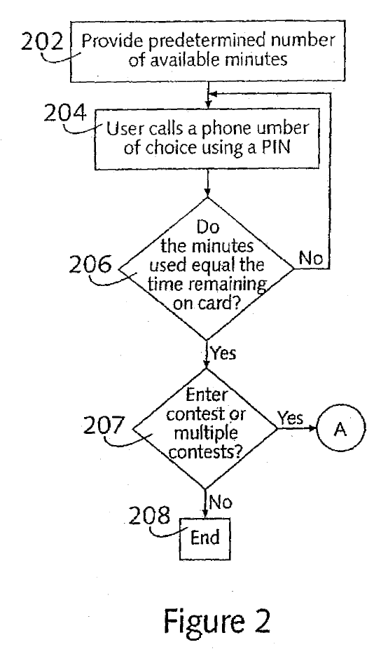

Referring now to FIG. 2, there is shown a flow chart of phone card operations. The card is provided with a predetermined number of minutes available, step 202.

A liaison company can be used to interact with retail stores and telecommunication companies. Such liaison companies typically receive a percentage of income for each minute purchased by the customer. In one embodiment of the invention, the telecommunications and entertainment company (TEC) also receives a percentage of income for each minute purchased by the consumer. A liaison is a point-of-service activation (POSA) and distribution partner for all major wireless carriers.

Phone cards are generally a prepaid method of making a long distance (domestic or international) call. Minutes means total time that can be used for one or more calls to one or more phone numbers (locations, area codes, countries). The cards can be used from any phone. Some prepaid phone cards can be refilled, usually by charging the additional cost to the user's credit card.

Prepaid phone cards represent telephone time a customer buys in advance. Users pay from $5 to $15, or more, up-front for local or long distance phone time. The amount of time bought depends on the rate-per-minute that is charged. The phone time is paid for in advance. Phone card companies keep track of how calling time is used by the PIN. Time can be added to some prepaid phone cards. The added cost can usually be billed to a credit card.

Pay as you go cards are prepaid mobile phone cards that are used with phones that the customer buys. Minutes are bought as needed. Prepaid cell phones allow the customer to pay for only the minutes needed.

For purposes of this disclosure, it should be understood that “telecommunications” includes but is not limited to landline telephones, cellular phones, T-mobile, Virgin Mobile, Slice, Bluetooth, Zune to Zune, iPhone, iFlops, camera phones, Motorola RAZR, NeXus satellite radio, MP3/DVD/CD/WMA receiver iPod and XM-ready, TracFone wireless, Chocolate, INpulse, Firefly, Ticketmaster, U3 Data Traveler, Walkman, ZenV, Impulse, Sirus Cable, Cable Service, Instant messaging, Internet Service and Communication, Television Communication, Radio Communication, Satellite Communication, Email, etc. Giving due respect to the adage, “time is money,” telecommunications time, as used herein, is considered to have a monetary value, so that items that have such monetary value are expressly considered herein to include but not be limited to telephone cards and the like.

The user calls a phone number using a PIN, step 204. Most prepaid phone cards display a toll-free access telephone number and PIN. The PIN can be provided by any one or more of the following techniques: printed numbers, bar codes, magnetic strips, or optical character recognition (OCR) printed symbols. Alternatively, this activation step 204 can be accomplished without the use of a predetermined PIN number and even with the use of a phone number.

Prepaid phone card companies have computers that use the user's PIN to keep track of the card usage—how much time the user has on the card in minutes or units. To make a phone call, the user dials the access number, enters the PIN, and at the voice prompt, enters the phone number of the party the user is trying to reach. A computer informs the user of how much time—or how many units—the user has left on the card, and how to use other features the card may offer. Typically, each unit equals one minute for a domestic call. If the prepaid phone card cannot be recharged—that is, if the user cannot buy additional minutes by phone for the card—the user must buy another card once the time is used up.

Carriers are responsible for the telephone lines that carry calls. Resellers buy telephone minutes from carriers. Issuers set the rates and provide toll-free customer service and access numbers.

The number of minutes remaining on the card equals the original number of minutes paid for, less time used with the card, rounded up, step 206. Rounding is the billing increment unit. One Minute Rounding means that the billing increment is 1 minute. A call for 50 seconds, for example, is billed as 1 minute. Three Minute Rounding means that the billing increment unit is 3 minutes. A call for 7 minutes and 50 seconds is billed as 9 minutes. One plus three Minute Rounding means that for calls less than 1 minute, the user is charged for 1 minute. For calls more than 1 minute, the first minute is charged 1 minute and the following minutes are charged at 3 minute increments. A call for 2 minutes and 50 seconds is billed as 4 minutes.

The user decides whether to enter a TEC contest, step 207. For purposes of this disclosure, a “contest” is intended to include, but not be limited to, a prize, a sweepstake, a chance and consideration for the acquisition thereof. The user can decide to enter the contest by following the directions on the package 10 (FIG. 1a). There may also be multiple contests available on the package. The user may enter as many of the contests as are available. The contests include but are not limited to membership rewards, shopping cards, retailer's cards, Sirius radio, cable or Internet service, best CD album, best artists, best lyrics, best song, best movie, best actor, best soundtrack, best director, best producer, best book, best game, Ticketmaster, event tickets, and the like.

It should be understood that land line service can be purchased, and used in connection with the present invention, in which case a discount is available to encourage a user to maintain and retain his land line service. Minutes or cash payable to a user's bill can be claimed by a user who avails himself of the inventive product and services.

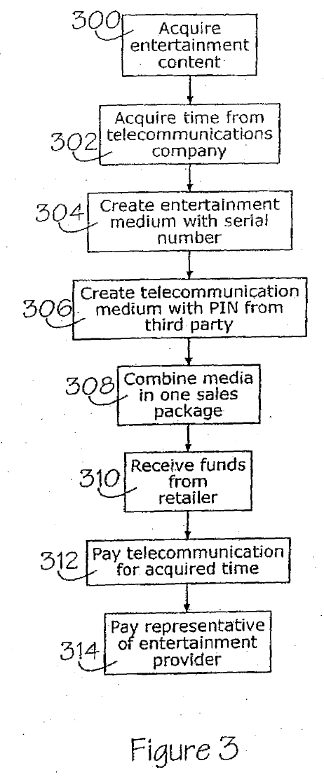

Referring now to FIG. 3, there is shown a flow chart of operations for acquiring and distributing entertainment content or combinations or bundles thereof and telecommunications options or combinations or bundles thereof. Entertainment content is acquired, step 300. The entertainment content may be movies on DVD, music on CD, music on mini-CD, books on DVD, stand up comedy on DVD, sports on DVD, events on DVD, exercise programming on DVD, music video on DVD, magician on DVD, history on DVD, the bible on DVD, dance on DVD, yoga on DVD, health on DVD, educational programs on DVD, gardening on DVD, magic shows on DVD, drivers training on DVD, cooking on DVD, stand up comedy on DVD, concerts on DVD, games, computer games on DVD, Game Boy, Nintendo DS, Nintendo GameCube, BlueRay, Nintendo WII, Play Station 2 and 3, PSP, entertainment cards that offer services, or gift cards for the purchase of certain entertainment products, and the like.

A license is acquired from the copyright holder for the use of music, movies, books, sports, events, games, exercise programming, computer games, Gameboy games, Gameboy Advance, Nintendo DS, Nintendo GameCube, Nintendo WII, Xbox, Playstation 2, Playstation 3, PSP, BlueRay, and the like. The content is in the form of a CD/DVD, but is not limited thereto. For example, other forms of expression (e.g., written material) are contemplated herein.

Time is acquired from one or more telecommunications companies, step 302. The purchased time is encoded on a magnetic strip across the phone card 16 (FIG. 1a). The time can be activated when sold, although certain phone cards are prepaid.

An entertainment medium is created with a serial number, step 304, the serial number being placed on the entertainment medium itself.

A telecommunications medium is created with a PIN number, step 306. The PIN is placed on the telecommunications card and/or bank credit card, debt card, ATM card, iTune, eMusic card, Internet service medium, gift card, membership card, rewards card, entertainment card, Ticketmaster, promotional card, celebrity card, and the like, which may or may not match other serial numbers within the package.

A liaison such as InComm Interactive Voice Response (IVR) system can give customers easy-to-follow prompts to enter the pin and account numbers located on their card or receipt. This information is communicated to the payment database at the InComm Data Center, which verifies the information and transmits it to the appropriate carrier for activation.

Handset activation technology is activated at the register. InComm has a direct connection with the major carriers and can automatically activate the headset by the electronic serial number (ESN).

A liaison company can be used to interact with retail stores and telecommunication companies. Such liaison companies typically receive a percentage of income for each minute purchased by the customer. In one embodiment of the invention, the telecommunications and entertainment company (TEC) also receives a percentage of income for each minute purchased by the consumer. A liaison is a point-of-service activation (POSA) and distribution partner for all major wireless carriers.

The telecommunications and entertainment media are combined in one package, step 308. Accordingly, the telecommunication and entertainment package now contains a phone card, a DVD or CD with entertainment programming, and a rewards contest. It should be understood, however, that for purposes of this disclosure, the single event that includes telecommunications and entertainment media may, in fact, be purchased at different times, at different locations, and via different methods (e.g., physical sale, mail order, email order, Internet sale, etc.), yet still be considered a single package, entity or transaction.

Funds are received from one or more retailers, step 310. The retailer reports the sale or rental of the telecommunications and entertainment package on a monthly basis, preferably, but other periodic or non-periodic time frames can be negotiated. The retailer forwards the money from the sale or rental of the telecommunication and entertainment package on a monthly or quarterly basis, but shorter or longer payment periods can be negotiated. For purposes of this disclosure, the words “sale”, “sell” and “selling” are intended to include the concepts of renting and rented.

Telecommunications companies are paid for the acquired time, step 312, by the TEC. Minutes are paid as they are used or may be paid all at once for the telecommunications and entertainment package when purchased.

A representative of the entertainment provider is paid, step 314. The provider of the entertainment receives funds after the telecommunications and entertainment package has been purchased and the money has been received from the sale.

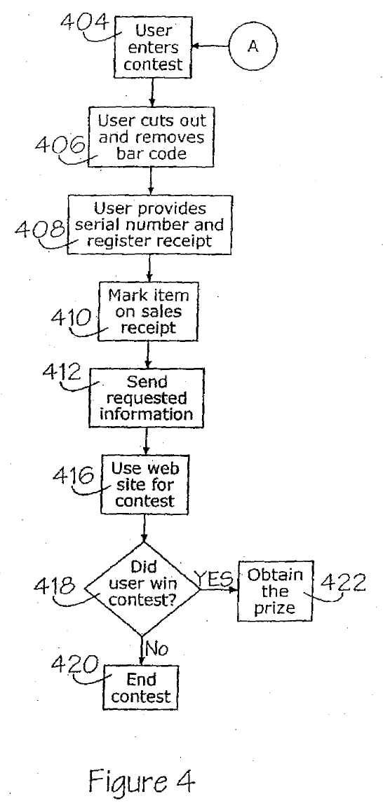

Referring now to FIG. 4, the user can enter a contest, step 404. By providing certain information along with a serial number, or multiple contest(s), the user mails or emails or calls in or otherwise conveys information requested from the telecommunications and entertainment package. In one embodiment, the user cuts out and removes the bar code on the telecommunications and entertainment package, step 406, and mails it with the required information.

The rules of the contest(s) require certain information and the serial number, or multiple serial numbers that pertain to the package, along with a register receipt, step 408. The serial number must be the correct number or multiple numbers that match the music, movies, games, books, sports, exercise programming, and the like. More than one person can win the contest and qualify for different prizes or the same prize. A purchaser who buys the entertainment package can also qualify to win multiple prizes merely by purchasing additional goods via a predetermined web site.

The user circles, highlights, clicks on or otherwise selects an item on his sale register receipt, step 410. The user circles the register receipt and mails or emails the bar code and the register receipt to the address on the telecommunications and entertainment package, step 412.

The web site is used to enter the contest or contests, step 416. The user can email certain information through the web site following the same process described hereinabove. If the user wins the contest, step 418, he can claim his prize, step 422.

The telecommunications and entertainment package holds one or more contests periodically to award a winner(s). The winner receives a prize selected by the telecommunications and entertainment company (TEC). The prize may be a car, a recreational vehicle, cash, stock, retail products, restaurant meals, a recording deal, travel, jewelry, clothing hotel reservations, special events, amusement parks fees, a movie deal, any other items or deals or combination thereof. The contest ends, step 420, when another customer wins a prize.

The user obtains the prize selected by the TEC at the time the company chooses. The date and location are chosen by the TEC, the terms of which may differ per contest. The method of shipment may be to pick up the prize at a certain designated location, by FedEx, UPS or regular mail service, or any other method of delivery that the telecommunications and entertainment company chooses. Any sales tax due on the prize will be paid for by the user in order to receive the prize by a certain date.

Advertisements may be printed or embossed on the outside packaging of package 10. The advertisement may also be included on the calling cards and/or the actual CD/DVDs themselves, or within the entertainment media so as to be displayed, performed or heard while listening to the CD/DVD or seen on a user's video display monitor.

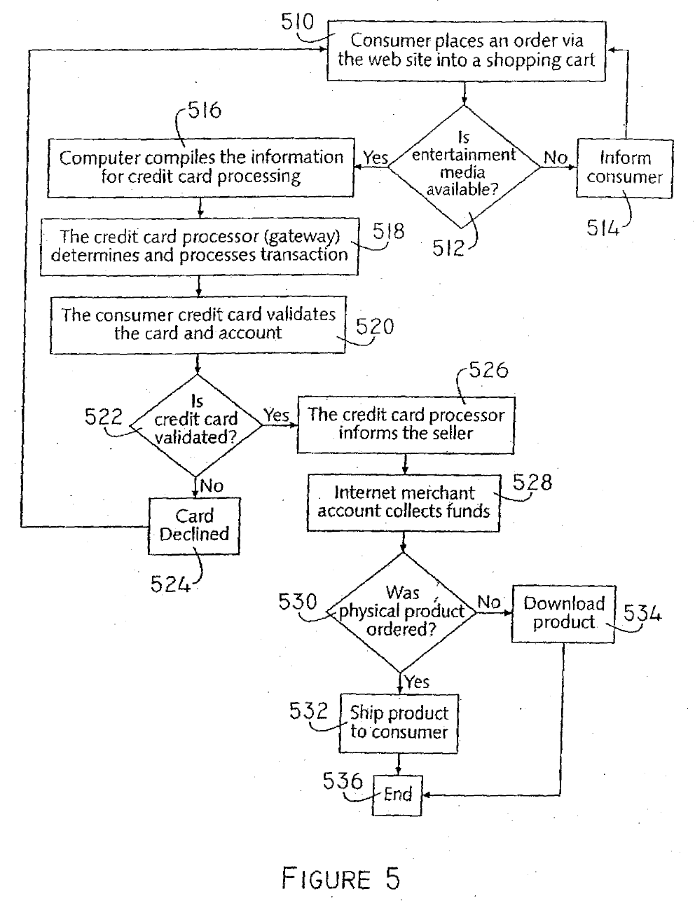

Referring now to FIG. 5, there is shown a flow chart of fulfillment operations in an Internet-based system. The consumer completes his order via a merchant's web store, step 510, specifying the number of minutes ordered and choice of entertainment. If the provider cannot fill the entertainment order, step 512, the customer is informed, step 514, and processing resumes from step 510.

The merchant's shopping cart program on the web host computer gathers the order information, step 516, compiling it into a suitable form for the credit card processing company.

The shopping cart transmits the formatted order from the web host to the credit card processor (payment gateway), step 518. The credit card processor checks the information received regarding the order to ensure all required information is sent to continue processing the transaction. The processor then determines what company manages the customer's credit card and transmits a request for the card to be charged, step 518.

The customer's credit card company validates the card and the account, step 520. If sufficient credit is not available, step 522, the system declines the card, step 524 and resumes processing at step 510. The credit card company also sends a code back to the credit card processor indicating the nature of the problem. If everything checks out correctly and the credit card is clear for purchases, the credit card company sends an acknowledgement back to the card processor that the amount requested can be transferred, step 520.

The credit card processor notifies the merchant's shopping cart program at the web host whether the transaction was successful, step 526. The shopping cart then can notify the customer if the order was complete and can send the order on to the merchant for delivery of the product or service. The credit card processor initiates a funds transfer (settlement request) to the merchant account company for deposit into the merchant's bank account that it has on record.

Internet merchant accounts collect the funds for a specified period of time, step 528, and make scheduled transfers to the merchant's regular bank account. The credit card processing transaction is complete.

The consumer chooses a method of delivery. The consumer may prefer to have a physical product shipped directly to him, step 530, in which case the physical product is shipped directly to the consumer, step 532. The consumer may prefer to download the product, step 534. The transaction is completed, step 536.

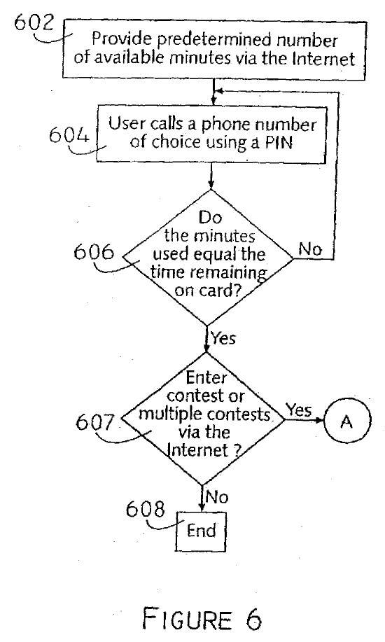

Referring now to FIG. 6, there is shown a flow chart of phone card operations. The card is provided with a predetermined number of minutes available, step 602.

A liaison company can be used to interact with retail stores and telecommunication companies. Such liaison companies typically receive a percentage of income for each minute purchased by the customer. In one embodiment of the invention, the telecommunications and entertainment company (TEC) also receives a percentage of income for each minute purchased by the consumer. A liaison is a point-of-service activation (POSA) and distribution partner for all major wireless carriers.

Phone cards are generally a prepaid method of making a long distance (domestic or international) call. Minutes means total time that can be used for one or more calls to one or more phone numbers (locations, area codes, countries). The cards can be used from any phone. Some prepaid phone cards can be refilled, usually by charging the additional cost to the user's credit card.

Prepaid phone cards represent telephone time a customer buys in advance. Users pay from $5 to $15, or more, up-front for local or long distance phone time. The amount of time bought depends on the rate-per-minute that is charged. The phone time is paid for in advance. Phone card companies keep track of how calling time is used by the PIN. Time can be added to some prepaid phone cards. The added cost can usually be billed to a credit card.

Pay as you go cards are prepaid mobile phone cards that are used with phones that the customer buys. Minutes are bought as needed. Prepaid cell phones allow the customer to pay for only the minutes needed.

For purposes of this disclosure, it should be understood that “telecommunications” includes but is not limited to landline telephones, cellular phones, T-mobile, Virgin Mobile, Slice, Bluetooth, Zune to Zune, iPhone, iFlops, camera phones, Motorola RAZR, NeXus satellite radio, MP3/DVD/CD/WMA receiver ipod and XM-ready, TracFone wireless, Chocolate, INpulse, Firefly, Ticketmaster, U3 Data Traveler, Walkman, ZenV, Impulse, Sirius cable, cable service, instant messaging, Internet service and communication, other networks, television communication, radio communication, satellite communication, email, etc.

Land line service can be purchased, and used in connection with the present invention, in which case a discount is available to encourage a user to maintain and retain his land line service. Minutes or cash payable to a user's bill can be claimed by a user who avails himself of the inventive product and services.

The user calls a phone number using a PIN, step 604. Most prepaid phone cards display a toll-free access telephone number and PIN. The PIN can be provided by any one or more of the following techniques: printed numbers, bar codes, magnetic strips, or optical character recognition (OCR) printed symbols. Alternatively, this activation step 604 can be accomplished without the use of a predetermined PIN number and even with the use of a phone number.

Prepaid phone card companies have computers that use the user's PIN to keep track of the card usage—how much time the user has on the card in minutes or units. To make a phone call, the user dials the access number, enters the PIN, and at the voice prompt, enters the phone number of the party the user is trying to reach. A computer informs the user of how much time—or how many units—the user has left on the card, and how to use other features the card may offer. Typically, each unit equals one minute for a domestic call. If the prepaid phone card cannot be recharged—that is, if the user cannot buy additional minutes by phone for the card—the user must buy another card once the time is used up.

Carriers are responsible for the telephone lines that carry calls. Resellers buy telephone minutes from carriers. Issuers set the rates and provide toll-free customer service and access numbers.

If the number of minutes remaining on the card does not equal the original number of minutes paid for, step 606, the user can continue using his minutes on the call or can make another call. If, however, the number of paid minutes is used up, step 606, the system enters a contest phase, step 607, described hereinbelow. Rounding is employed for the billing increment unit. One Minute Rounding means that the billing increment is 1 minute. A call for 50 seconds, for example, is billed as 1 minute. Three Minute Rounding means that the billing increment unit is 3 minutes. A call for 7 minutes and 50 seconds is billed as 9 minutes. One plus three Minute Rounding means that for calls less than 1 minute, the user is charged for 1 minute. For calls more than 1 minute, the first minute is charged 1 minute and the following minutes are charged at 3 minute increments. A call for 2 minutes and 50 seconds is billed as 4 minutes.

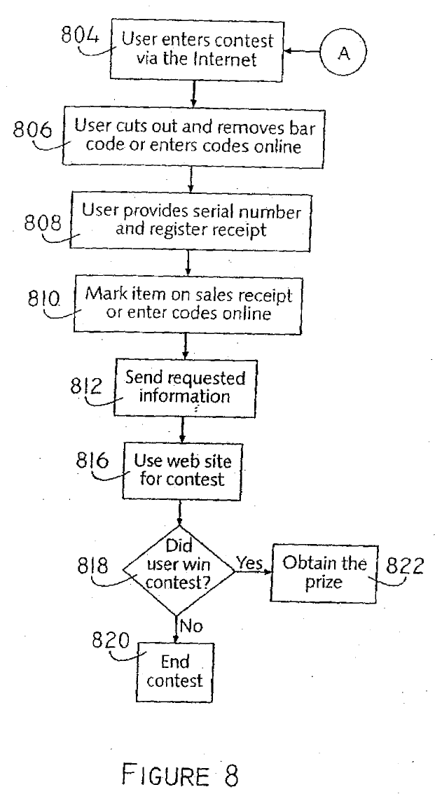

The user decides whether to enter a TEC contest, step 607. For purposes of this disclosure, a “contest” is intended to include, but not be limited to, a prize, a sweepstake, a chance and consideration for the acquisition thereof. The user can decide to enter the contest by following the directions on the package and/or online. There may also be multiple contests available on the package. The user may enter as many of the contests as are available. The contests include but are not limited to membership rewards, shopping cards, retailer's cards, Sirius radio, cable or Internet service, best CD album, best artists, best lyrics, best song, best movie, best actor, best soundtrack, best director, best producer, best book, best game, Ticketmaster, event tickets, and the like. If the user decides not to participate in a contest, step 607, processing determinates, step 608. Processing resumes at “A” which is shown in detail at FIG. 8.

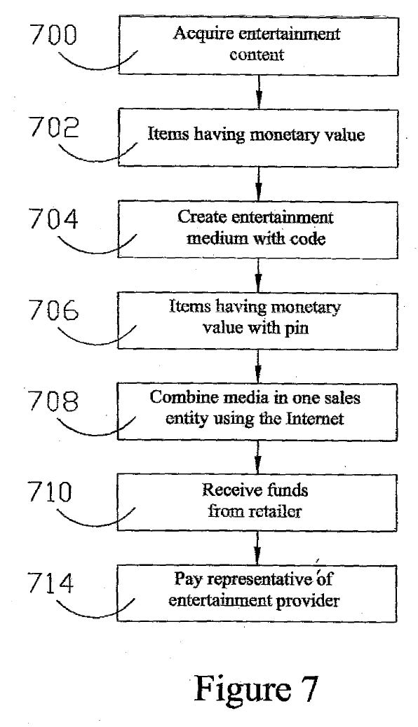

Referring now to FIG. 7, there is shown a flow chart of operations for acquiring and distributing entertainment content or combinations or bundles thereof, and items having monetary value or combinations or bundles thereof. Entertainment content is acquired, step 700. The entertainment content may be movies on DVD, music on CD, music on mini-CD, books on DVD, stand up comedy on DVD, sports on DVD, events on DVD, exercise programming on DVD, music video on DVD, magician on DVD, history on DVD, the Bible on DVD, dance on DVD, yoga on DVD, health on DVD, educational programs on DVD, gardening on DVD, magic shows on DVD, drivers training on DVD, cooking on DVD, stand up comedy on DVD, concerts on DVD, games, computer games on DVD, Game Boy, BlueRay, Nintendo DS, Nintendo GameCube, Nintendo WII, Play Station 2 and 3, PSP, entertainment cards that offer services, or gift cards for the purchase of certain entertainment products, and the like. Such entertainment content may also include theater tickets, sport events tickets, movie tickets, concert tickets and the like.

A license is acquired from the copyright holder for the use of music, movies, books, sports, events, games, exercise programming, computer games, Gameboy games, Gameboy Advance, Nintendo DS, Nintendo GameCube, Nintendo WII, Xbox, Playstation 2, Playstation 3, BlueRay, Internet services such as Napster, PSP, and the like. The content is in the form of a CD/DVD, but is not limited thereto. For example, other forms of expression (e.g., written material) are contemplated herein.

Items having monetary value, including but not limited to, credit cards, gift cards, debit cards, vouchers, coupons, subscriptions and services, step 702. The monetary value of the items can be activated when sold.

An entertainment medium can be created with a code, step 704, the code being placed on the entertainment medium itself.

An item having monetary value is created with a PIN number, step 706. The PIN is placed on the item having monetary value, such as a bank credit card, debit card, ATM card, iTune, eMusic card, Internet service medium, gift card, membership card, rewards card, entertainment card, Ticketmaster, promotional card, celebrity card, and the like, which may or may not match other codes within the package.

A liaison such as InComm Interactive Voice Response (IVR) can give customers easy-to-follow prompts to enter the PIN and account numbers located on their card or receipt. This information is communicated to the payment database at the InComm Data Center, which verifies the information and transmits it to the appropriate carrier for activation.

Handset activation technology is activated at the register. InComm has a direct connection with the major carriers and can automatically activate the headset by the electronic serial number (ESN).

A liaison company can be used to interact with retail stores and banking, brokerage, or retail establishments. A liaison is a point-of-service activation (POSA) and distribution partner.

The items having monetary value and the entertainment media are combined and/or bundled in one package, step 708. Accordingly, the items of monetary value and the entertainment package now contains a credit card or gift card, etc., a DVD or CD with entertainment programming, and a rewards contest.

Funds are received from one or more retailers, step 710. The retailer reports the sale or rental of the items having monetary value and entertainment package on a monthly basis, preferably, but other periodic or non-periodic time frames can be negotiated. The retailer forwards the money from the sale or rental of the items having monetary value and entertainment package on a monthly or quarterly basis, but shorter or longer payment periods can be negotiated. For purposes of this disclosure, the words “sale”, “sell” and “selling” are intended to include the concepts of renting and rented.

A representative of the entertainment provider is paid, step 714. The provider of the entertainment receives funds after the items of monetary value and entertainment package has been purchased and the money has been received from the sale.

Referring now to FIG. 8, as aforementioned, the user can enter a contest, step 804. By providing certain information along with a serial number, or multiple contest(s), the user mails or emails or calls in or otherwise conveys information requested from the telecommunications and entertainment package. In one embodiment, the user cuts out and removes the bar code on the telecommunications and entertainment package, step 806, and mails it with the required information.

The rules of the contest(s) require certain information and the serial number, or multiple serial numbers that pertain to the package, along with a register receipt, step 808. The serial number must be the correct number or multiple numbers that match the music, movies, games, books, sports, exercise programming, and the like. More than one person can win the contest and qualify for different prizes or the same prize. A purchaser who buys the entertainment package can also qualify to win multiple prizes merely by purchasing additional goods via a predetermined web site.

The user circles, highlights, clicks on or otherwise selects an item on his sale register receipt, step 810. The user circles the register receipt and mails or emails the bar code and the register receipt to the address on the telecommunications and entertainment package, step 812.

The web site is used to enter the contest or contests, step 816. The user can email certain information through the web site following the same process described hereinabove. If the user wins the contest, step 818, he can claim his prize, step 822; otherwise, processing terminates, step 820.

The telecommunications and entertainment package holds a contest periodically to award a winner. The winner receives a prize selected by the telecommunications and entertainment company. The prize may be a car, a recreational vehicle, cash, stock, retail products, restaurant meals, a recording deal, travel, jewelry, clothing hotel reservations, special events, amusement parks fees, a movie deal, any other items or deals or combination thereof. The contest ends, step 820, when another customer wins a prize.

The user obtains the prize selected by the TEC at the time the company chooses. The date and location are chosen by the TEC, the terms of which may differ per contest. The method of shipment may be to pick up the prize at a certain designated location, by FedEx, UPS or regular mail service, or any other method of delivery that the telecommunications and entertainment company chooses. Any sales tax due on the prize will be paid for by the user in order to receive the prize by a certain date.

Advertisements may be printed or embossed on the outside packaging of the package. The advertisement may also be included on the calling cards and/or the actual CD/DVDs themselves, or within the entertainment media so as to be displayed, performed or heard while listening to the CD/DVD or seen on a user's video display monitor.

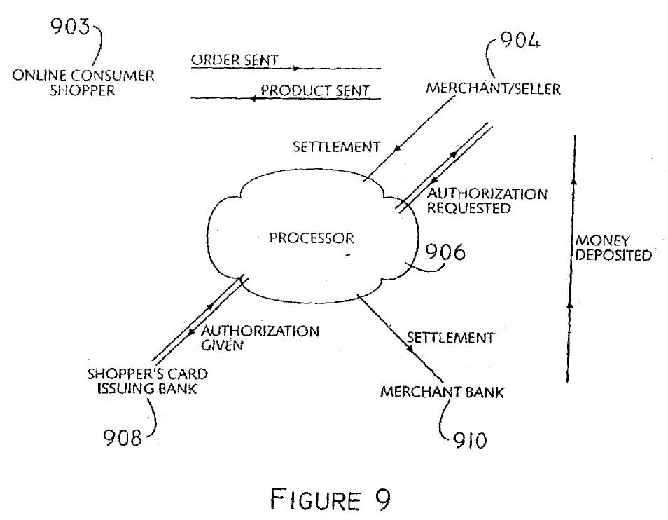

Referring now to FIG. 9, there is shown a flow chart of operations of point of purchase using a credit card. An online payment gateway account (the online card processor) and/or an Internet merchant account may be used. Though these are two separate components of credit card processing, they are usually necessary and work together to handle payments automatically. The consumer 903 makes a purchase, which is sent to the seller 904. The seller 904 sends the order to a processor 906 for authorization. The processor 906 sends the order onto the consumer's issuing bank 908 for authorization. The issuing bank 908 gives the authorization by sending the authorization back to the processor 906. The processor 906 sends the authorization onto the seller 904 that the product authorization has cleared and that the product ordered can be shipped. The seller 904 ships the product. The processor 906 sends the authorization settlement to the seller's bank 910 that a purchase has been made and has cleared. The seller's bank 910 deposits the money into the account of the seller 904.

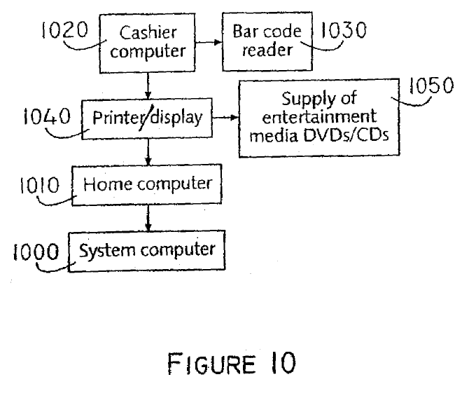

Referring now to FIG. 10, there is shown a block diagram showing flow from point of purchase of a commercial item through the consumer and thence to the medium containing entertainment content. A system computer 1000 is provided and accessible via an Internet connection. System computer 1000 includes at least one database, not shown, that contains information to allow tracking of items and transactions based on conditions, functions, attributes, labels, characters, and systems. The database(s) include information, operating systems, operations, fundamental features, limits, tables and views, indexes, other objects, external links, implementations, sources, logs, transactions, updates, documents, links to other stores, concurrency controls, query optimizers, and the like, to complete the sale of a commercial product and the providing of entertainment content. For purposes of this description, the system computer 1000 is intended to include one or more databases, as aforementioned, computers, memory, connections, hardware, providers, structures, platforms, applications, software, information systems, digital circuitry, read-only memory (ROM), embedded systems, open source hardware, design services, test delivery and logistics, network services, communications, integration, processing, and the like.

Connected to system computer 1000 via an Internet connection is a customer's home computer 1010, which may optionally be used in a method disclosed hereinbelow.

A cashier computer or checkout station 1020 is also provided at a retail store, not shown. Cashier computer 1020 is operatively connected to a device 1030 for entering information relative to a commercial item, not shown. Device 1030 may be a bar code scanner, as shown, or any equivalent device for entering such information including, but not limited to a keyboard or voice-operated I/O device, an infrared device, an optical, magnetic or SAW device, a fingerprint, retina, or voice scanner.

A printer and/or display 1040 connected to the cashier computer 1020 provides information for the cashier to direct the customer to redeem his entertainment medium, such as a CD or DVD, coupon or rewards gift. Located either at the checkout station or at another part of the retail store is a supply 1050 of entertainment media.

A consumer may prefer the commercial item to be shipped directly to him or to be printable by him, via the Internet. The consumer first fills the appropriate order form and adds a shipping and handling fee. An email address is mandatory for online orders, and many times the PIN codes are sent by email. The consumer may also fill out the order form online and choose the preferred delivery method. After the consumer logs into his account, he can check his purchase history. The consumer is able to print a receipt. After a consumer logs onto his account and fills in the needed information regarding his transaction, he can print the PIN codes or card templates.

Both online “payment gateway account” (the online card processor) and an “Internet merchant account” is used. Though these are two separate components of credit card processing, they are both necessary and work together to handle payments automatically.

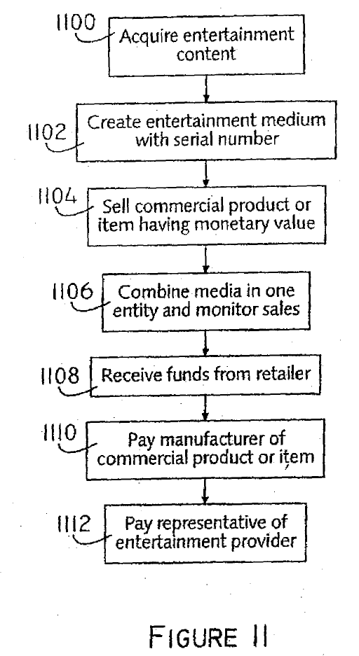

Referring now to FIG. 11, there is shown a flow chart of manufacturer/distribution operations in acquiring and distributing entertainment content and selling the commercial item. One of the first steps in practicing the inventive system is to acquire entertainment content, step 1100. The entertainment content may be movies on DVD, music on CD, music on mini-CD, books on DVD, stand up comedy on DVD, sports on DVD, events on DVD, exercise programming on DVD, music video on DVD, magician on DVD, history on DVD, the bible on DVD, dance on DVD, yoga on DVD, health on DVD, educational programs on DVD, gardening on DVD, magic shows on DVD, drivers training on DVD, cooking on DVD, stand up comedy on DVD, concerts on DVD, games, computer games on DVD, Game Boy, Nintendo DS, Nintendo GameCube, Nintendo WII, Play Station 2 and 3, PSP, entertainment cards that offer services, or gift cards for the purchase of certain entertainment products, digital files residing on electronic devices such as memory sticks, non-volatile memory cards, MP3 players, optical storage disks, multimedia cards, SanDisk, Apple iPods, solid state devices (ROMs), Bluetooth handsets, Blackberry devices, HP iPAQ, Palm, Zune to Zune, iFlops, MP3 pillows, Virgin Mobile, Slice, Zen Micro Photo MP3, T-Mobile, cellular telephones, Xbox, Nintendo WII, Nintendo DS, Nintendo GameCube, Gameboy, computer games, PSP, Play Station, TracFone, Chocolate, INpulse, Firefly, U3 Data Traveler, sport event tickets, theater tickets, Digital MP3 WMA, ZenV, Walkman, MP3 FM tuner, iMovie, Boom Box, iPod Nano, iPod Talking Shoe, Audiovox Xpress, Micro SD, XM card, satellite radio digital music, Flicker Photos, mobile prepaid plan cards, pay-as-you-go wireless, Internet service cards, laptop cards, mobile phone cards, landline telephones, cellular phones, Virgin Mobile, Slice, iPhone, Bluetooth, camera phones, Motorola RAZR, NeXus satellite radio, MP3/DVD/CD/WMA receiver iPod and XM-ready, Ticketmaster, band credit cards, debit cards, ATM cards, Internet service, gift card, membership card, rewards card, promotion card, celebrity card, ring tones, photo card, merchandise cards, entertainment cards, Amp'd card, promotional cards, wireless gift card, YouTube, Kiosk, music downloads, movie downloads, parents cards, points cards, electronic video cards, Free Leader, gphone, mobile caller, itune7, PDA's, TracFone, WIFI, BlueRay, mobile web and email, SanDisk Sansa, CB radio, walkie-talkie, digital cable, HBO, Cinemax, DVR service, boost mobile, Xing tone software, Broadband cards, cash and non-cash rewards, Travel & Entertainment cards (T&E), house cards, Napster, Mobile TV, air travel cards, Sunnysoft calling cards, cards, Pennytalk, Microsoft Max, Photo MP3, Corel Snapfire, cash and non-cash rewards, points cards, satellite radio digital music, Internet-based applications, including Flicker Photos, iPhone, T-Mobile, STI mobile, Net10, Edge and WIFI laptop PC cards (T-Mobile), Smartphones, subscription services, Express cards, T-Mobile to Go, Text messaging, Java Games, WAV/AAC/AACT music players, walkman, PC card, USB modem, video share calling, micro SD, mini SD, Media players, DMX digital music, Facebook, MySpace, social networks, subscriptions, Sansa Connect music players, MMS, QuickShare, messaging packing MSN,YAHOO, AOL, ICQ, AIM, Billboards, multimedia messaging, data download speed burst, upload burst, 2way SMA, dual band, Quad-Band (GPRS/EDGE), worldwide communication, instant messenger, Edge technology high speed data, Yahoo Messenger, and the like.

A license is acquired from the copyright holder for the use of music, movies, books, sports, events, games, exercise programming, computer games, Gameboy games, Gameboy Advance, Nintendo DS, Nintendo GameCube, Nintendo WII, Xbox, BlueRay services, Playstation 2, Playstation 3, PSP, and the like. The content generally resides in media in the form of a CD or DVD, but is not limited thereto. For example, other forms of expression (e.g., written material) are contemplated herein.

The entertainment medium is also created with a code or serial number, step 1102, the serial number, not shown, being placed on the entertainment medium itself and may be humanly readable, although the serial number may be embodied in a magnetic stripe, a bar code or any other machine-readable form.

A commercial item, not shown, is then sold at the retail store or via the Internet, step 1104. Commercial items or products include but are not limited to food items, automotive, accessories, consumer electronics, electronic devices, hardware, textile, toys, sporting goods, specialty items, specialty services, stationery, crafts, books, footwear, health and beauty items, collectibles, home and garden items, jewelry, linens, clothing, pottery, glassware, computers and computer products, service, gift certificates, cameras, art, antiques, CDs, DVDs or any other media for storing entertainment content, video games, Zune to Zune, iPod, MP3, Blackberry, PDA, entertainment card, Internet services, computer games, entertainment services, memory card, entertainment content, memorabilia, and the like.

Advertisements may be printed or embossed on the outside packaging of the commercial item as well as on the entertainment media themselves, or within the entertainment media so as to be displayed, performed or heard while listening to the CD/DVD or seen on a customer's video display monitor.

The commercial items themselves may also include a serial number associated with the system computer 1000 (FIG. 10) or the entertainment medium. The retail seller may choose to shelve both commercial item and entertainment medium associated therewith together or may choose to provide the entertainment medium at a location remote from the commercial item and/or from the checkout station 1020 (FIG. 10). For purposes of this description, the commercial item or product and the entertainment medium are considered a single entity, even if provided in separate packages. Similarly, the transaction regarding the purchase of the commercial item and the delivery of the entertainment medium is considered a single transaction, even if the portions thereof are separated by time and distance (e.g., when the customer consummates downloading of the entertainment content via the Internet and his home computer 1010 (FIG. 10)).

The system allows a customer to purchase a commercial product, step 1106, and be rewarded with free or discounted entertainment content such as reside on a DVD, CD, games, electronic devices, or downloads, which entertainment content may also be provided via a download operation by the customer at a later time and different place via the Internet and his home computer, PDA, Blackberry, telephone, iPod, or MP3 player. A ticket or voucher relating to theater performances, concerts, sports events, and the like, can also be received by the customer at the cash register once a purchase is made.

It should be understood that downloading in any type of file, streaming, formats, shared networks, subscription downloads that requires set fees or monthly fees, encoded formats, laser, writing data, or other electronic devices, including, but not limited to, downloading subscription services from providers is considered a form of downloading. Providers include AT&T, Verizon, cable networks, telephones, PDA and Blackberry services, Time Warner, and the like. There are at least two ways of downloading: formats or common ways of encoding transmission of audio or video, and other forms of entertainment media. Moreover, a customer can purchase a download, or multiple downloads, for example, at a participating retail establishment, and use the cash register receipt (proof of purchase) to input the code printed thereon into his computer, PDA, Blackberry, etc. to receive his ordered merchandise (e.g., downloads, products, etc.). This operation is also considered a single package.

The system computer 1000 may be programmed to limit the number or type of rewards (e.g., entertainment content and media) according to the number, type and cost of commercial items sold to a single customer or family or household, or the frequency of such sales and locations thereof. Thus, the mere purchase of an inexpensive item such as a box of tissues may or may not be sufficient to justify a free movie on DVD, or a free CD. Similarly, credit card use many reward a customer only upon reaching certain levels of spending above say, $500. Moreover, a customer who purchases a number of items, such as a pair of shoes, in one day could be restricted to only one reward.

The organization receives appropriate funds from the seller or retailer, step 1108. The seller also pays the manufacturer or distributor of the commercial item, step 1110, although such payment can be made at an earlier stage of the process, depending upon the agreement reached between manufacturer, distributor and seller. Similarly, the organization, seller or distributor pays a representative of the entertainment provider, step 1112, pursuant to the agreement reached between entertainment media manufacturer or distributor and seller.

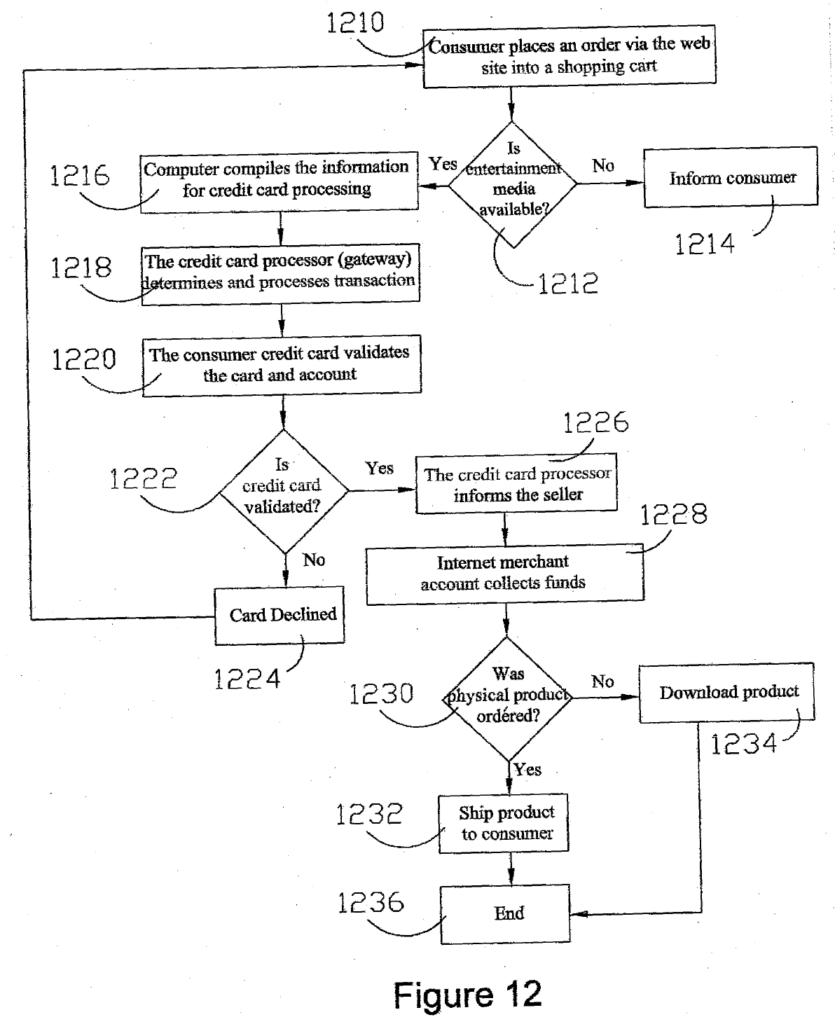

Referring now to FIG. 12, there is shown a flow chart of merchant operations for commercial items purchased over the Internet. The consumer completes his order via a merchant's web store, step 1210, specifying the item or product ordered and, optionally, choice of entertainment. If the provider cannot fill the entertainment order, step 1212, the customer is informed, step 1214, and processing resumes from step 1210.

The merchant's shopping cart program on the web host computer gathers the order information, step 1216, compiling it into a suitable form for the credit card processing company.

The shopping cart transmits the formatted order from the web host to the credit card processor (payment gateway), step 1218. The credit card processor checks the information received regarding the order to ensure all required information is sent to continue processing the transaction. The processor then determines what company manages the customer's credit card and transmits a request for the card to be charged, step 1218.

The customer's credit card company validates the card and the account, step 1220. If sufficient credit is not available, step 1222, the system declines the card, step 1224, and resumes processing at step 1210. The credit card company also sends a code back to the credit card processor indicating the nature of the problem. If everything checks out correctly and the credit card is clear for purchases, the credit card company sends an acknowledgement back to the card processor that the amount requested can be transferred, step 1220.

When the credit card is validated, step 1222, credit card processor notifies the merchant's shopping cart program at the web host whether the transaction was successful, step 1226. The shopping cart then can notify the customer if the order was complete and can send the order on to the merchant for delivery of the product or service. The credit card processor initiates a funds transfer (settlement request) to the merchant account company for deposit into the merchant's bank account that it has on record.

Internet merchant accounts collect the funds for a specified period of time, step 1228, and make scheduled transfers to the merchant's regular bank account. The credit card processing transaction is complete.

The consumer chooses a method of delivery. The consumer may prefer to have a physical product shipped directly to him, step 1230, in which case the physical product is shipped directly to the consumer, step 1232. The consumer may prefer to download the product, step 1234. The transaction is completed, step 1236.

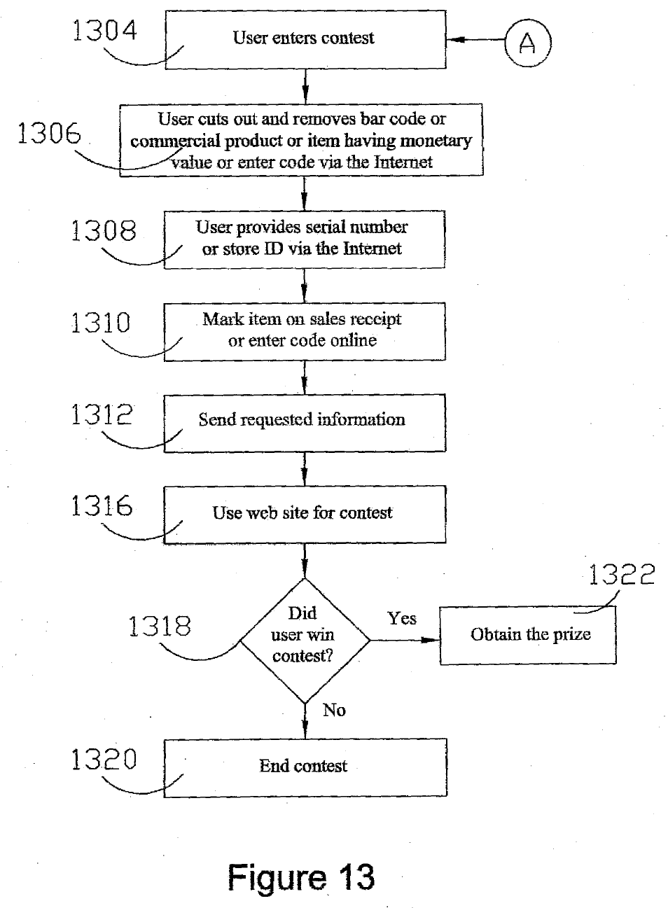

Referring now to FIG. 13, the customer can enter a contest, step 1304, which is held periodically to award a winner. The winner receives a prize selected by the inventive organization. The contests include but are not limited to a car, a recreational vehicle, cash, stock, retail products, restaurant meals, a recording deal, travel, jewelry, clothing hotel reservations, special events, amusement parks fees, a movie deal, membership rewards, shopping cards, retailer's cards, satellite radio, cable or Internet service, best CD album or DVD movie that include best artists, best lyrics, best song, best movie, best actor, best soundtrack, best director, best producer, best book, best game, Ticketmaster, event tickets, any other items or deals or combination thereof.

For purposes of this disclosure, a “contest” is intended to include, but not be limited to, a prize, a sweepstake, a chance and consideration for the acquisition thereof. The customer can decide to enter the contest by following the directions on the commercial item package, the entertainment medium, and/or online. There may also be multiple contests available on the commercial item package or entertainment medium. The customer may enter as many of the contests as are available.

By providing certain information along with a serial number, or multiple contest(s), the customer mails or emails or calls in or otherwise conveys information requested from the commercial item or entertainment medium. In one embodiment, the customer cuts out and removes the bar code on the commercial item package or entertainment medium, step 1306, and mails it with the required information.

The rules of the contest(s) require certain information and the code or serial number, or multiple serial numbers that pertain to the commercial item package and/or entertainment medium, along with a register receipt, step 1308. The serial number must be the correct number or multiple numbers that match the music, movies, games, books, sports, exercise programming, and the like. More than one person can win the contest and qualify for different prizes or the same prize. A purchaser who buys the entertainment package can also qualify to win multiple prizes merely by purchasing additional goods via a predetermined web site.

The customer circles, highlights, clicks on or otherwise selects an item on his sale register receipt, step 1310. The customer circles the register receipt and mails or emails the barcode and the register receipt to the address on the commercial item and/or entertainment medium, step 1312.

The web site is used to enter the contest or contests, step 1316. The customer can email certain information through the web site following the same process described hereinabove. If the customer wins the contest, step 1318, he can claim his prize, step 1322; otherwise, processing terminates, step 1320. The contest ends, step 1320, when another customer wins a prize.

The customer obtains the prize selected by the inventive organization at the time the company chooses. The date and location, the terms of which may differ per contest, are chosen by the company. The method of shipment may be to pick up the prize at a certain designated location, by FedEx, UPS or regular mail service, or any other method of delivery that the telecommunications and entertainment company chooses. Any sales tax due on the prize will be paid for by the customer in order to receive the prize by a certain date.

The system allows the consumer to distinguish the method, model, application, channels in which the system uses to significantly reduce the operational cost for the consumer, as well as the seller. The system optimizes business transactions and automatically maximizes two products as one sale. The consumer may need to a computer, data, hardware, software, to comply with the requirements, via the Internet.

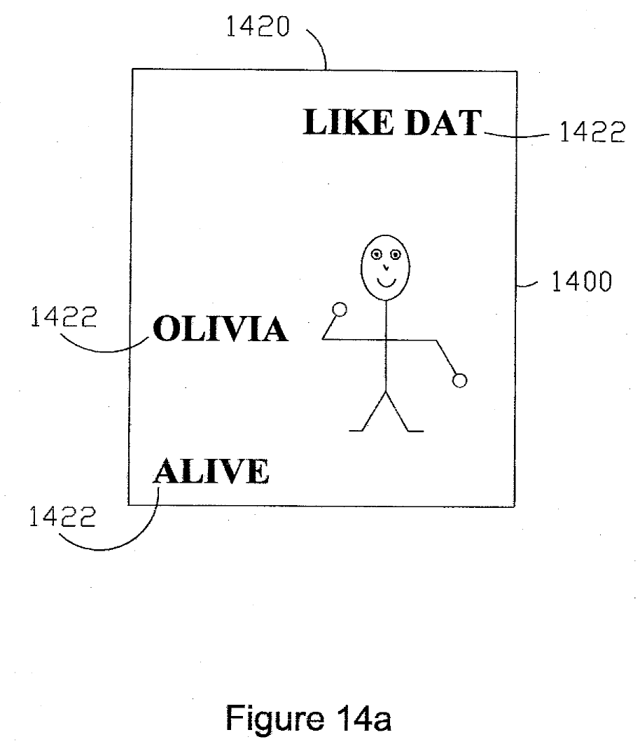

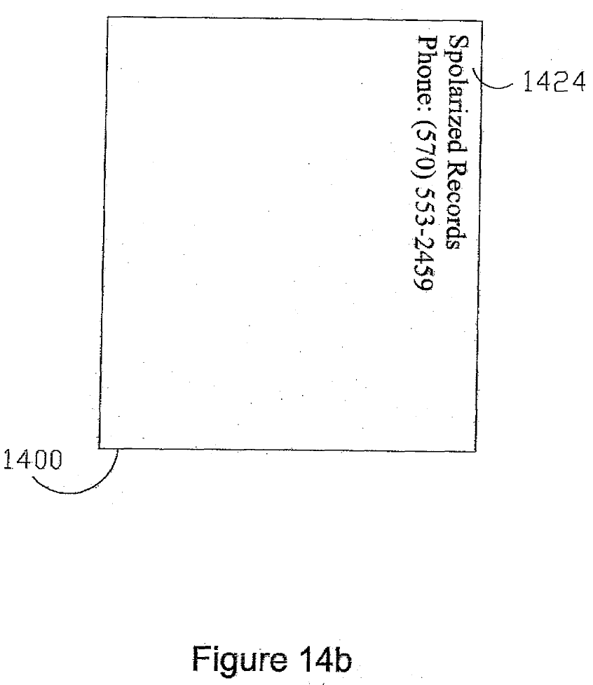

Referring now to FIGS. 14a and 14b, there is shown generally at reference number 1400 a postcard, a rectangular piece of thin paper or thin cardboard with decorative print of photographs, scenes, advertisement, and such, on one side or both, intended for writing, for advertisement, for mailing without an envelope or used as a handout. Written material, such as the advertisement for a Spolarized® product, for example shown as reference number 1422, can be printed on either or both front and rear sides of substrate 1420. The written material may be used for advertising products of other manufacturers or vendors.

The system is any type of advertisement, including but not limited to communication unpaid ads such as word-of-mouth, spread the buzz, tell a friend, a catch phrase, social networks.

A logo, trademark such as Spolarized®, content wrap, radio, television, commercials, telephone, Internet, organizations, public service announcements, register receipts, skywriting, shopping networks, coupons, Google, pop-ups, phone cards, streetcars, promotions, guerrilla, social networks, MySpace, Facebook, Second Life, text messages, billboards, web banners, mobile phones and screens, seat back tray tables, shopping carts, streaming audio, downloads, motion pictures, ad trading, media buy or targeting, credit cards, gift cards, debit cards, ATM cards, phone cards, and the like; supermarkets, passenger screens, logo jets, in-flight advertisement, rack cards, Super Bowl football, events, including but not limited to sport events, religious events, entertainment events, educational events, retail sales events, food events, carnivals, amusement parks, tours, music in advertising, infomercials, websites, message boards, content wraps, announcement centers, media, world wide web, spam, email, companies, international space station, corporate logos, announcements, printed public notices, broadcast pitch, satellite TV and radio, bandages, Internet devices such as TiVo and software, digital signing, BlueRay, public service announcements, cable networks, watches, cars, scarf, clothing, stickers on foods like apples, Band-Aids, diapers, mouse pads, overhead storage bins, VISA cards, ATM; and debit cards typically attempts to persuade potential customers to purchase or to consume more of a particular brand of products or services, or to potential customers make aware of such goods, services, and organization's events.

The advertisements used in this system are designed to generate increased consumption of those products and services, and events, through the creation and reinforcement of brand image and brand loyalty, or to sell tickets at venues. The advertisements can take many other forms like magazines, newspapers, coupons, bandages, printed material, postcards, register receipts, posters, calling cards, and the like. Many of the advertisements such as streetcars, billboards, tickets, seatbacks tray tables, wallpaper, international space station, companies, watches, clothing, cards, photos, commercial items, debit cards, visa cards, gift cards, buses, shopping carts, software, devices like TiVo, automotive, corporate logos, supermarkets, gas stations, shopping malls, the sides of buildings, banners, elastic bans on diapers, passenger screens, airlines in-flight ads, subway trains, announcement centers, content wraps, message boards, commercial items, and the like, can be placed in heavy traffic areas so the consumer can view the ads.

Advertisements can embed in the head a message. These types of advertisements are used as persuasive messages often with factual information. Every major medium is used to deliver these messages, including but not limited to television, radio, cinema, video, video games, the Internet, movies, music, social groups, organizations, political campaigns, interest groups, bus stops, public service announcements, non-profit groups, audio, visa cards, debit cards, gift cards, phone cards, public address systems, visual auto, printed rack cards and flyers, town criers, taxicabs, subway platforms and trains, street corners, gas stations, overhead storage bins, sidewalks, stickers on fruits, the opening section of streaming, audio and video, event tickets, advertising, supermarkets and chain stores, receipts at retailer stores, street furniture, trashcans, music stage shows, TV stage shows, promotions, telephones, websites, popups, phone screens, airports, stores, religious groups, military, announcement centers, BlueRay, message boards, content wraps, digital signing, spam, emails, sidewalks, sides of buildings, satellite TV and radio, worldwide web, MySpace, Facebook, Second Life, and the like, streaming audio, subliminal advertising, text messaging, social networks, web banners, cable TV, shop TV, MTV, VH1 and BET, other networks, product placement, infomercial, skywriting, online advertising, and the like, often placed by an advertising agency on behalf of a company, a club, or other organizations. The system helps the participating retailers, merchants, distributors, manufacturing companies and the like, learn what trends, styles, choices, clubs, organizations, Internet users want and expect from the participating parties along with their customers' likes and dislikes.

The system offers a more innovative involvement for the consumer, such as interactively choosing to text message, or various innovation social networking sites (e.g., MySpace, Facebook, Second Life) through the system the consumer can enjoy passing along a message.

A user may hear by word-of-mouth or a phrase such as, “sell it” or “ell a friend” or “spread the buzz” or a catch phrase like, “Spolarized® Energized”, indicating that a particular combination or a bundling package is available through a system. The user must than communicate to a participating supplier that he wants to use the system. Suppliers such as mass market chain stores, merchants, banks, gas stations, movie theaters, concerts, fairs, festivals, bowling alleys, art galleries, dances, retailers, casinos, attractions, farmer markets, live theaters, parks, racetracks, libraries, zoos, worship centers, WiFi hotspots, theme parks, museums, fund raisers, flea markets, merchant accounts, bingo centers, arenas and stadiums, clubs, events, political parties, Internet groups, military recruiters, churches, organizations, sport events, Internet, companies, groups, social networks, taverns, amusement centers, google, Yahoo, Facebook, MySpace, Second Life, lodging places, restaurants, food courts, salons, barber shops, spa areas, pharmacies, networking centers, coffee shops, cruises, wineries, pubs, dinner theaters, comedy clubs, shopping malls, pet stores, body building clubs, automotive shops, specialty stores, sport bars, and the like, are participating suppliers able to activate promotional content and offer the specified combined or bundled package to a consumer.

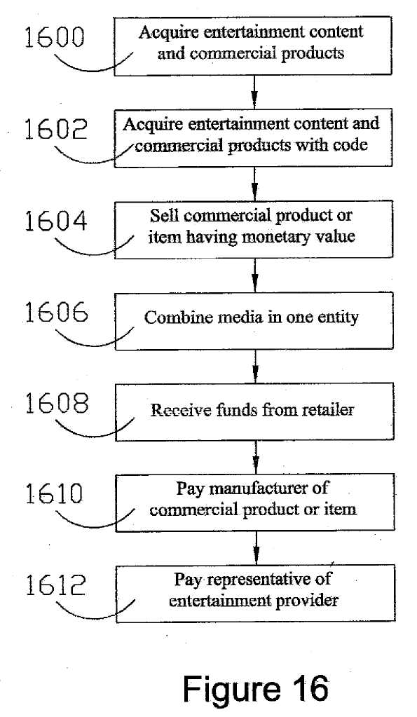

One or more content of specified items is set up within the system for a more cost-effective way for a customer to shop. More particularly, the user may want to use the system to its fullest extent by combining and/or bundling multiple specified items and also utilizing the contests. The system offers greater efficiency and instant gratification to the user when the user communicates by word-of-mouth, catch phrases, social networks, or by handing promotional products, such as postcards, flyers, stickers, calling cards, newspapers, magazines, gift cards, event tickets, movie tickets, announcement flyers, including but not limited to, or by way of the Internet, text messaging, cell phones, including but not limited, to a participating supplier indicating to them, that the user would like to use the system, of one or more content, combining and bundling, but not limited to such things as, a commercial product, entertainment item, information or business transaction, items having monetary value, as a single purchase. Combining and bundling is described in greater detail with reference to FIG. 16, below.

A registration serial number, not shown, is embedded in the advertisement 1422 and optional advertisement (word-of-mouth advertising) communication, media, radio and TV, and through language, can also be used to provide the serial number. The serial number is discussed in greater detail below. Moreover, advertising from multiple vendors on both sides of card 1400, can be printed.

The serial number identifies a system in which advertisement actives a combining and/or bundling of certain items. Moreover, the serial number can be activated through all forms of advertisement, embedded in sound and or images before, during or after the content is stored itself, for play or displayed to the user, including, but not limited to, word-of-mouth, communication, catch phrases, phones, phone cells, text messaging, television, radio, cable networks, screen savers, digital signing, music, Internet, games, popups, sky writing, walkie-talkie, phone cards, Google, Yahoo, networks, softwares, MSN, tickets, register receipts, sound, songs, movies, Facebook, MySpace, Second Life, social groups, websites, stickers on fruits, Band-Aids, overhead storage bins, clothing, cars, promotional material, CD/DVD's, announcements, message boards, satellite radio, land-line, and the like.

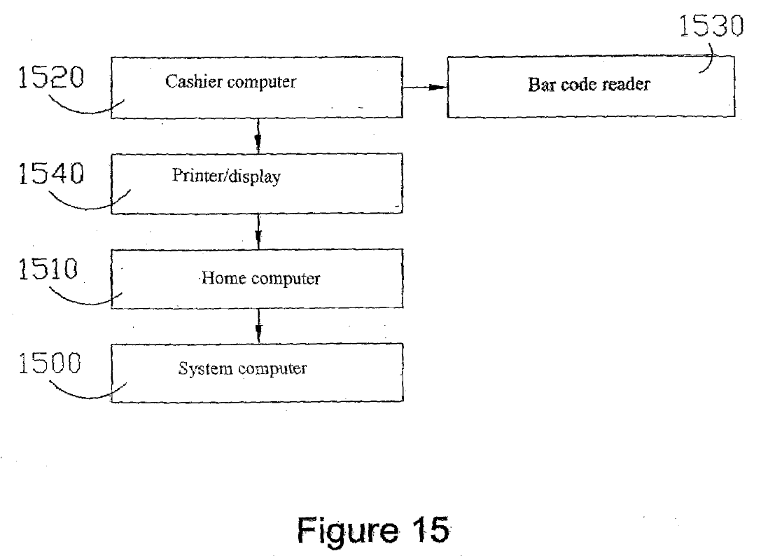

Referring now to FIG. 15, there is shown a block diagram of a system, wherein advertisement and promotional items activate a purchase which bundles one or more commercial products, items having monetary value, business transactions, and entertainment content. A system or cashier computer 1500 is provided and accessible via an Internet connection. The cashier computer 1500 computes exact change, simplifies the cashier's role, involves the packing patron, tracks everything, prepares audit data, and provides reports. Cashier computer 1500 is set up to minimize leakage and track every penny that is due. Cashier computer 1500 works the pricing, sales, and promotions. It handles inventory and payment processing.

Cashier computer 1500 includes at least one database, not shown, that contains information to allow tracking of items and transactions based on conditions, functions, attributes, labels, characters, and systems. The database(s) include information, operating systems, operations, fundamental features, limits, tables and views, indexes, other objects, external links, implementations, sources, logs, transactions, updates, documents, links to other stores, concurrency controls, query optimizers, and the like, to complete the sale of an advertisement or promotional item with one or more commercial products, items having monetary value, business transactions, and entertainment content. For purposes of this description, the cashier computer 1500 is intended to include one or more databases, as aforementioned, as well as computers, memory, connections, hardware, providers, structures, platforms, applications, software, information systems, digital circuitry, read-only memory (ROM), embedded systems, open source hardware, design services, test delivery and logistics, network services, communications, integration, processing, and the like.

Connected to cashier computer 1500 via an Internet connection is a customer's home computer 1510, which may optionally be used in a method disclosed hereinbelow.

A cashier computer or checkout station 1520 is also provided at a retail store, not shown. Cashier computer 1520 can be any device capable of handling monetary transactions including, but not limited to, point-of-sale (POS) systems, Microsoft Dynamics, retail management systems, cash tellers, Casio PCR, Palm Pilot, barcode scanners, IBM, Royal, Samsung, and First Data systems. Cashier computer 1520 is operatively connected to a device 1530 for entering information relative to a commercial item, not shown. Device 1530 may be a bar code scanner, as shown, or any equivalent device for entering such information including, but not limited to, a keyboard or voice-operated I/O device, an infrared device, an optical, magnetic or SAW device.

A printer and/or display 1540 connected to the cashier computer 1520 provides information for the cashier to direct the customer to redeem his advertisement bundle medium, such as a commercial product, coupon or rewards gift.

A consumer may prefer the commercial item to be shipped directly to him or to be printable by him, via the Internet. The consumer first fills the appropriate order form and adds a shipping and handling fee. An email address is mandatory for online orders, and many times the PIN codes are sent by email. The consumer may also fill out the order form online and choose the preferred delivery method. After the consumer logs into his account, he can check his purchase history. The consumer is able to print a receipt. After a consumer logs onto his account and fills in the needed information regarding his transaction, he can print the PIN codes or card templates.

Consumers are more likely to buy items that offer something, that are discounted, have a coupon, or perhaps have a rewards program. A consumer likes to feel that he is receiving a saving of some sort. A consumer also likes to save time. Therefore, combining commercial products, entertainment items, information and business transactions, and/or things having monetary value benefit the consumer as well as the advertiser. The system represents a more efficient way for the advertiser to make sure the consumer pays attention to the ads and reads its advertisement.

In order for the user to use the system and activate the advertisement material and purchase the combined or bundled package, the user must visit the physical location of one of the participating suppliers, retailers, vendors, merchants, tellers, sponsor, restaurants, churches, schools, colleges, clubs, events, organizations, and the like, that are set up within the system.

In the inventive combined system a participating retailer, merchant, distributor, and/or a manufacturing company, organization, school, college, club, church, gas station, mass market chain store, fitness center, event, movie theater, concerts, bowling alleys, and the like, sets up one or more combined commercial products, entertainment items, information and business transactions, or items having monetary value, that is purchased as one sale. For example a combine package would consist of a promotional material, or word-of-mouth, or through communication, a flyer, a postcard, a billboard ad, a radio ad, a TV advertisement, a text message, a catch phrases, a public school or college announcement, an event flyer, mobile phone ads, and the like, in which the participating party has set up to become a participating partner with their promotional material or by word-of-mouth.

The combined package along with the promotional advertisement may consist of but not be limited to a download of a movie, a song, a Bluetooth, a game, a ticket to the movies, a ticket to a concert, a gift card, a jar of applesauce, a gallon of milk, a sport event, a dinner at the McDonald's restaurant, perhaps information or business transaction, or uses of a visa, a phone card, and the like, one or more items, in any combination. Moreover, the combined package may offer the combination including but not limited to, making a transaction in a bank, in a certain restaurant, in a drug store, in a grocery store, or at an ATM machine, purchase a gallon of milk, or purchase a jar of peanut butter, or purchase a can of coffee, or purchase of a gallon of wine, or purchase toothpaste, and may also ask the user to purchase one or more items such as a download of a movie, a purchase of a song, a toothbrush, an apple, or an orange, a in any combination, of commercial products, entertainment items, information and business transactions, or items having monetary value, as a combined package purchase.

In the inventive bundled package system a participating retailer, merchant, distributor, and/or a manufacturing company, organization, school, college, club, church, gas station, mass market chain store, fitness center, event, movie theater, concerts, bowling alleys, and the like, sets up one or more combined commercial products, entertainment items, information and business transactions, or items having monetary value, which are purchased as one sale. For example a bundled package consist of one or more promotional materials, or word-of-mouth, or through communication, a flyer, a postcard, a billboard ad, a radio ad, a TV advertisement, a text message, a catch phrases, a public school or college announcement, an event flyer, mobile phone ads, and the like, in which the participating party has set up to become a participating partner with their promotional material or by word-of-mouth.

The bundled package along with the promotional advertisement may consist of but not be limited to, multiple items such as a download of a movie or movies, a song or songs, a game or games, tickets to the movies, tickets to concerts, a gift card, two jars of applesauce, two gallons of milk, sport events, two dinners at the McDonald's restaurant on two different nights, perhaps information or business transaction, or uses of a visa, buy a phone card, and the like, one or more items, in any combination. Moreover, the bundle package may offer any combination but not limited to, making a transaction in a bank, in a certain restaurant, in a drug store, in a grocery store, or at an ATM machine, purchase a gallon of a milk, jar of peanut butter, or purchase a can of coffee, or purchase of a gallon of wine, or purchase toothpaste, and may also ask the user to purchase one or more items such as, a download of a movie, a purchase of a song, a toothbrush, an apple, or an orange, a in any combination, of commercial products, entertainment items, information and business transactions, or items having monetary value, as a bundle package purchase.

Referring now to FIG. 16, there is shown a flow chart of manufacturer/distribution operations in acquiring and distributing entertainment content and selling at least one commercial product. It should be understood that commercial products may be intangible, such as services, business transactions, and entertainment items and can be combined or bundled as described hereinbelow.

Other forms of the entertainment media such as, but not limited to, entertainment cards (i.e., a card representative of monetary funds for entertainment content), can be provided, as desired, without departing from the scope of the invention. Since entertainment includes providing amusement (events, performances, recreational activities) to at least one person, other forms of the entertainment media include, but are not limited to, digital files residing on electronic devices such as memory sticks, non-volatile memory cards, MP3 players, optical storage disks, multimedia cards, SanDisk, Apple iPods, solid state devices (ROMs), Bluetooth handsets, Blackberry devices, HP iPAQ, Palm, Zune to Zune, iFlops, MP3 pillows, Virgin Mobile, Slice, Zen Micro Photo MP3, T-Mobile, cellular telephones, Xbox, Nintendo WII, Nintendo DS, Nintendo GameCube, Gameboy, computer games, PSP, Play Station, TracFone, Chocolate, INpulse, Firefly, U3 Data Traveler, Digital MP3 WMA, ZenV, theater tickets, sport event tickets, Walkman, MP3 FM tuner, iMovie, Boom Box, iPod Nano, ipod Talking Shoe, Audiovox Xpress, Micro SD, XM card, satellite radio digital music, Flicker Photos, mobile prepaid plan cards, pay-as-you-go wireless, Internet service cards, laptop cards, mobile phone cards, landline telephones, cellular phones, Virgin Mobile, Slice, iPhone, Bluetooth, camera phones, Motorola RAZR, NeXus satellite radio, MP3/DVD/CD/WMA receiver iPod and XM-ready, Ticketmaster, band credit cards, debit cards, ATM cards, Internet service, gift card, membership card, rewards card, promotion card, celebrity card, ring tones, photo card, merchandise cards, entertainment cards, Amp'd card, promotional cards, wireless gift card, YouTube, Kiosk, music downloads, movie downloads, parents cards, points cards, electronic video cards, Free Leader, gPhone, mobile caller, social networks, Facebook, MySpace, itune7, PDA's, TracFone, WIFI, BlueRay, mobile web and email, SanDisk Sansa, CB radio, walkie-talkie, digital cable, HBO Cinemax, DVR service, boost mobile, Xing tone software, Broadband cards, cash and non-cash rewards, Travel & Entertainment cards (T&E), house cards, Napster, Mobile TV, air travel cards, Sunnysoft calling cards, cards, Pennytalk, Microsoft Max, Photo MP3, Corel Snapfire, cash and non-cash rewards, points cards, satellite radio digital music, Internet-based applications, including Flicker Photos, iPhone, T-Mobile, STI mobile, Net10, Edge and WIFI laptop PC, cards (T-Mobile), Smartphones, Express cards, T-Mobile to Go, Text messaging, Java Games, WAV/AAC/AACT music players, walkman, PC card, USB modem, video share calling, micro SD, mini SD, Media players, MMS, QuickShare, messaging packing MSN,YAHOO, AOL, ICQ, AIM, Billboards, multimedia messaging, data download speed burst, upload burst, 2way SMA, dual band, Quad-Band(GPRS/EDGE) worldwide communication, BlueRay, instant messenger, social networks, Edge technology high speed data, Yahoo Messenger, and the like.

One of the first steps in practicing the inventive system is to acquire entertainment content and commercial products, step 1600. The commercial product may include, but not be limited to, bread, milk, eggs, toothpaste, hair spray, apples, clothing, gift cards, VISA cards, debit cards,. ATM, phone cards, shoes, socks, cars, automotive, bikes, furniture, jewelry, and the like. Content for business transactions may include but not be limited to, using a VISA card, ATM, debit cards, phone cards, gift cards, and the like. Content of monetary funds may be, but not be limited to tickets, events, gifts, transactions, and the like. Content of entertainment may include, but not be limited to, CD/DVD movies, games, software, programs, phones, Internet, music players, electronic devices, and the like.

The entertainment medium is also associated with a code, step 1602, the code being placed on the items having monetary value, a business transaction, and/or entertainment medium itself and may be humanly readable, although the code may be embodied in a magnetic stripe, a bar code or any other machine-readable form. Of course, if the medium for disseminating the code is not tangible (e.g., only by word-of-mouth), such code is not placed on the items or business transactions. It should be understood that the term code includes, but is not limited to, codes, passwords, keywords, slogans, serial numbers, and phrases.

A commercial item is then sold at the retail store or via the Internet, step 1604. Commercial items include business transactions, services, and products that include but are not limited to food items, automotive, accessories, bread, milk, toilet paper, gift cards, VISA cards, debit cards, phone cards, consumer electronics, electronic devices, hardware, textile, toys, sporting goods, specialty items, specialty services, stationery, crafts, books, footwear, health and beauty items, collectibles, home and garden items, jewelry, linens, clothing, pottery, glassware, computers and computer products, service, gift certificates, cameras, art, antiques, CDs, DVDs or any other media for storing entertainment content, video games, Zune to Zune, iPod, MP3, Blackberry, PDA, entertainment card, computer games, entertainment services, memory card, entertainment content, memorabilia, and the like.

A license is acquired from the copyright holder for the use of music, movies, books, sports, events, games, exercise programming, computer games, Gameboy games, Gameboy Advance, Nintendo DS, Nintendo GameCube, Nintendo WII, Xbox, Playstation 2, Playstation 3, PSP, and the like. The content generally resides in media in the form of a CD or DVD, but is not limited thereto. For example, other forms of expression (e.g., written material) are contemplated herein. A license may or may not be acquired for commercial products.

The system allows a customer to purchase a commercial product and be rewarded with free or discounted entertainment content such as reside on a DVD, CD, game, electronic device, download, step 1606, which entertainment content may also be provided via a download operation by the customer at a later time and different place via the Internet and his home computer, PDA, Blackberry, telephone, iPod or other electronic device.

The organization receives appropriate funds from the seller or retailer, step 1608. The seller also pays the manufacturer or distributor of the commercial item, step 1610, although such payment can be made at an earlier stage of the process, depending upon the agreement reached between manufacturer, distributor and seller. Similarly, the organization, seller or distributor pays a representative of the entertainment provider, step 1612, pursuant to the agreement reached between the entertainment media manufacturer or distributor and seller.

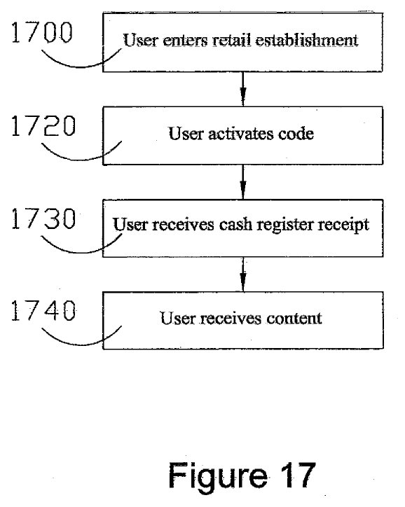

Referring to FIG. 17, the customer enters a participating (physical or Internet), retail establishment, and pays for his product(s), step 1700. The customer then can use his register receipt, if he has obtained one, to identify and activate his code, step 1720, for proffering to a participating retail or Internet establishment at a later time.

A customer can purchase one or more downloads, theater tickets, sport event tickets, concert tickets, commercial products, entertainment items, business transactions, items of monetary value and information, and the like, by activating advertisement (code), step 1720. Once the customer makes a purchase at the register, he then may use the cash register receipt (proof of purchase), step 1730, to input the code printed thereon into his computer, PDA, Blackberry, etc. to receive his ordered merchandise (e.g., downloads, products, etc.), or receive physical products at the retail establishment itself, step 1740. In other words, physical products (e.g., theater tickets, sport event tickets, concert tickets, commercial products, entertainment items, business transactions, or items of monetary value and information) may be available at the participating retail establishment. The activating advertisement code completes the transaction of the combined and bundled system. This multi-step operation is also considered a single package.

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

Having thus described the invention, what is desired to be protected by Letters Patent is presented in the subsequently appended claims.

What is claimed is:

1. A method for acquiring and distributing combined or bundled products in a single transaction, the steps comprising:
a) identifying goods and services;
b) allowing a second party to advertise at least one content, said advertising including a predetermined code associated with said content;
c) allowing a third party to offer at least one of the group: commercial products, entertainment items, business transactions, information, and things of monetary value; and
d) upon acceptance of said predetermined code, activating the advertisement to allow a customer to acquire content.

2. The method for acquiring and distributing combined or bundled products in accordance with claim 1, the steps further comprising:
e) communicating information representative of said offering of said content by a customer so that said customer is authorized via said code to receive said content.

3. The method of acquiring and distributing combined or bundled products in accordance with claim 1, wherein said second party and said third party represent the same party.

4. The method for acquiring and distributing combined or bundled products in accordance with claim 1, wherein said allowing a third party to offer step (c) comprises allowing said third party to sell or donate.

5. The method for acquiring and distributing combined or bundled products in accordance with claim 1, wherein said allowing a third party to offer step (c) is performed via the Internet.

6. The method for acquiring and distributing combined or bundled products in accordance with claim 1, the steps further comprising:
e) conducting at least one contest for a customer based on information associated with said code.

7. The method for acquiring and distributing combined and bundled products in accordance with claim 1, wherein at least one element of said content comprises entertainment content embodied in a medium chosen from the group: CD, mini-CD, DVD, phone card, iPhone card, iTune card, eMusic card, debit card, credit card, Internet file, digital file residing on electronic devices, memory sticks, non-volatile memory cards, MP3 players, optical storage disks, multimedia cards, SanDisk, Apple iPods, solid state devices (ROMs), Bluetooth handsets, Blackberry devices, HP iPAQ, Palm, Zune to Zune, iFlops, MP3 pillows, Zen Micro Photo MP3, T-Mobile, cellular telephones, Xbox, Nintendo WII, Nintendo DS, Nintendo GameCube, Gameboy, computer games, PSP, Play Station 2 and 3, TracFone, Chocolate, INpulse, Firefly, U3 Data Traveler, Digital MP3 WMA, ZenV, Walkman, MP3 FM tuner, iMovie, Boom Box, iPod Nano, iPod Talking Shoe, Audovox Xpress, Micro SD, XM card, satellite radio digital music, Internet-based application, Flicker Photos, Yahoo Messenger, mobile prepaid plan cards, pay-as-you-go wireless, Internet service cards, laptop cards, mobile phone cards, land line telephones, cellular phones, Virgin Mobile, Slice, Bluetooth, camera phones, iPhone, Motorola RAZR, NeXus satellite radio, MP3/DVD/CD/WMA receiver iPod and XM-ready, Ticketmaster, band credit card, ATM card, Internet service, gift card, membership card, rewards card, promotional card, celebrity card, ring tones, photo card, merchandise cards, entertainment card, music download, free loader, parents load, electronic video games, kiosks cards, mobile tracker, Amp'd card, promotional card, music downloads, movie downloads, electronic video games, YouTube, kiosks cards, cash and non-cash cards, points cards, satellite radio, GPhone, wireless gift cards, mobile caller, camera phone, itune7, PDA's, Trac-Fone, WIFI, BlueRay, mobile web and email, social networking systems, subscriptions and services, SanDisk, CB radio, walkie-talkie, digital cable, HBO Cinamax, DVR service, boost mobile, Xing tone software, Broadband cards, digital music, Micro Max, Photo MP3, Coral Snapfire, Napster, Mobile TV, Travel and Entertainment cards (T&E), Pennytalk, air travel, Sunnysoft calling cards, no-fee cards, cardless cards, T-Mobile, my Faves, cellular video, STI mobile, Smartphones, Net10, Edge and WIFI laptop PC card (T-Mobile), Go Phones, DMX digital music, Sansa Connect music players, Express card, USB modem, PC card, walkman, Text messaging, Facebook, MySpace, Second Life, Java games, social networks, T-Mobile to Go, video share calling, micro SD, Video streaming, media players, MMS, QuickShare, subscription services, mini SD, Edge technology high speed data, messaging packing MSN/YAHOO/AOL/AIM/ICQ, Billboards, multimedia messaging, data download speed burst, upload burst, 2way SMS, dual band, Quad-band (GPRS/EDGE) worldwide communication, stereo wireless, GPS enabled, WAC/AAC/AACT music player, wireless gift card, events, goods sold on the Internet.

8. The method acquiring and distributing combined or bundled products in accordance with claim 7, wherein said allowing a second party to advertise step (b) comprises printing or displaying or announcing a message with said code by means of at least one of: printed matter, broadcasting, computer communications, word-of-mouth, skywriting, billboards, magazines, newspapers, coupons, bandages, printed material, postcards, register receipts, posters, calling cards, streetcars, billboards, tickets, logos, seatbacks tray tables, wallpaper, international space station, companies, watches, clothing, cards, photos, commercial items, buses, shopping carts, software, devices like TiVo, automotive, corporate logos, supermarkets, gas stations, shopping malls, the sides of buildings, banners, elastic bans on diapers, passenger screens, airlines in-flight ads, subway trains, announcement centers, content wraps, message boards, commercial items, content wrap, radio, television, commercials, Internet, organizations, public service announcements, register receipts, skywriting, shopping networks, coupons, Google, streetcars, promotions, guerrilla, social networks, MySpace, Facebook, Second Life, text messages, billboards, web banners, mobile phones and screens, seat back tray tables, shopping carts, streaming audio, downloads, motion pictures, ad trading, media buy or targeting, credit cards, gift cards, debit cards, ATM cards, phone cards, and the like; supermarkets, passenger screens, logo jets, in-flight advertisement, rack cards, Superbowl football, events, including but not limited to sport events, religious events, entertainment events, educational events, retail sales events, food events, carnivals, amusement parks, tours, music in advertising, infomercials, websites, message boards, content wraps, announcement centers, media, world wide web, spam, email, companies, telephones, television, radio, cinema, video, video games, the Internet, movies, music, social groups, organizations, political campaigns, interest groups, bus stops, social networks, public service announcements, non-profit groups, audio, public address systems, visual auto, printed rack cards and flyers, town criers, taxicabs, subway platforms and trains, street corners, gas stations, overhead storage bins, sidewalks, stickers on fruits, the opening section of streaming, audio and video, event tickets, advertising, supermarkets and chain stores, receipts at retailer stores, street furniture, trashcans, music stage shows, TV stage shows, promotions, websites, phone screens, airports, stores, religious groups, military, announcement centers, BlueRay, message boards, content wraps, digital signing, spam, emails, sidewalks, sides of buildings, satellite TV and radio, worldwide web, and the like, streaming audio, subliminal advertising, text messaging, web banners, cable TV, shop TV, MTV, VH1 and BET, other networks, product placement, infomercial, skywriting, online advertising, and the like.

9. A single entity for providing advertisement relating to the purchase of commercial products, comprising:
a) a first medium for holding entertainment content; and
b) a commercial product.

10. The single entity for providing advertising relating to the purchase of commercial products in accordance with claim 9, wherein said first medium comprises at least one from the group: CD, mini-CD, DVD, phone card, iPhone card, iTune card, eMusic card, debit card, credit card, Internet file, digital file residing on electronic devices, memory sticks, non-volatile memory cards, MP3 players, optical storage disks, multimedia cards, SanDisk, Apple iPods, solid state devices (ROMs), Bluetooth handsets, Blackberry devices, HP iPAQ, Palm, Zune to Zune, iFlops, MP3 pillows, Zen Micro Photo MP3, T-Mobile, cellular telephones, Xbox, Nintendo WII, Nintendo DS, Nintendo GameCube, Gameboy, computer games, PSP, Slice, Play Station, TracFone, Chocolate, INpulse, Firefly, U3 Data Traveler, Digital MP3 WMA, ZenV, Walkman, MP3 FM tuner, iMovie, Boom Box, iPod Nano, iPod Talking Shoe, Audovox Xpress, Micro SD, XM card, satellite radio digital music, Internet-based application, Flicker Photos, Yahoo Messenger, mobile prepaid plan cards, pay-as-you-go wireless, Internet service cards, laptop cards, mobile phone cards, land line telephones, cellular phones, Virgin Mobile, Slice, iPhone, Bluetooth, camera phones, Motorola RAZR, NeXus satellite radio, MP3/DVD/CD/WMA receiver iPod and XM-ready, Ticketmaster, band credit card, ATM card, Internet service, gift card, membership card, rewards card, promotional card, celebrity card, ring tones, photo card, merchandise cards, entertainment card, Amp'd card, promotional card, walkie-talkie, digital cable, mobile web and email, SanDisk, CB radio, Gphone, mobile caller, movie downloads, music downloads, Photo cards, travel and entertainment cards, YouTube, Kiosk cards, parents cards, points cards, electronic video cards, Free Leader, Itune7, PDA's, Trac-Fone, WIFI, BlueRay, SanDisk Sansa, HBO Cinamax, DVR service, boost mobile, Xing tone software, theater tickets, sport event tickets, Broadband cards, Napster, Travel and Entertainment card (T&E), Pennytalk software calling cards, air travel, house cards, Mobile TV, Microsoft Max, Photo MP3, Corel Snapfire, no-fee cards, cardless calling cards, mobile tracker, cash and noncash cards, video streaming, T-Mobile, Dash phone, my Faves, cellular video, STI mobile, Smartphones, Net10, Go Phones, Express cards, Edge and WIFI laptop PC card (T-Mobile), USB modem, PC card, walkman, text messaging, Java games, video share calling, video streaming, media players, DMX digital music, Sansa Connect music, MMS, microSD, miniSD, Edge technology high-speed data, Quick Share, messaging packing AIM/MSN/YAHOO/AOL/ICQ, Billboards, multimedia massaging, auto and video downloads, data download speed burst, upload burst, 2way SMS, dual band, Quad-Band (GPRS/EDGE) worldwide communication, subscription services, stereo wireless, GPS enabled, WAV/AAC/AACT music player, and wireless gift card.

11. The single entity for providing advertising relating to the purchase of commercial products in accordance with claim 10, further comprising a second medium, wherein said second medium comprises at least one from the group: CD, mini-CD, DVD, phone card, iPhone card, iTune card, eMusic card, debit card, credit card, Internet file, digital files residing on electronic devices, memory sticks, non-volatile memory cards, MP3 players, optical storage disks, multimedia cards, SanDisk, Apple iPods, solid state devices (ROMs), iPhone, Bluetooth handsets, Blackberry devices, HP iPAQ, Palm, Zune to Zune, iFlops, MP3, MP3 pillows, Virgin Mobile, Slice, Zen Micro Photo MP3, T-Mobile, cellular telephones, Xbox, Nintendo WII, Nintendo DS, Nintendo GameCube, Gameboy, computer games, PSP, Play Station, theater tickets, sport event tickets, TracFone, Chocolate, INpulse, Firefly, U3 Data Traveler, Digital MP3 WMA, ZenV, Walkman, MP3 FM tuner, Move Boom Box, iPod Nano, iPod Talking Shoe, Audiovox Xpress, Micro SD, XM card, satellite radio digital music, Internet-based application, including Flicker Photos, NeXus satellite radio, MP3/DVD/CD/WMA receive ipod and XM-ready, Ticketmaster, band cards, band credit cards, Internet service, gift cards, laptop cards, pay-as-you-go-cards, gPhone, MP3/DVD/CD/WMA receiver iPod and XM-ready, Internet service, gift cards, rewards cards, promotional cards, membership cards, celebrity cards, entertainment cards, ring tones, photo card, merchandise card, Amp'd card, pay-as-you-go-wireless, wireless gift card, YouTube, Kiosk, music downloads, movie downloads, parents card, points card, electronic video cards, Free Loader, landline telephone, mobile caller, itune7, PDA's, TracFone, WIFI, Blue Ray, mobile web and email, SanDisk Sana, CB radio, walkie-talkie, digital cable, HBO Cinemax, DVR service, boost mobile, Xing tone software, Broadband cards, cash and non-cash cards, satellite radio digital music, Napster, Microsoft Max, Photo MP3, Corel Snapfire, Mobile TV, house cards, travel and entertainment cards (T&E), Pennytalk, Sunny software calling cards, no-fee cards, cardless cards, T-Mobile, my Faves, cellular video, STI mobile, Smartphones, Net10, Edge and WIFI laptop PC card (T-Mobile), T-Mobile to Go, Go Phone, Express card, USB modem, PC card, walkman, text messaging, auto and video media, Java games, video share calling, micro SD, video streaming, mini SD, edge technology high speed data, MMS, media players, QuickShare, messaging packing AIM/MSN/YAHOO/AOL/ICA, Billboards, subscription services, DMX digital music, Sansa Connect music players, multimedia messaging, data download speed burst, upload burst, 2way SMS, dual band, Quad-Band (GPRS/EDGE) worldwide communication, stereo wireless, GPS enabled, WAV/AAC/AACT music player, and Yahoo Messenger.

12. The single entity for providing advertising relating to the purchase of commercial products in accordance with claim 9, further comprising:
c) means for qualifying a customer to participate in at least one contest.

13. The single entity for providing advertising relating to the purchase of commercial products in accordance with claim 9, further comprising at least one advertising message, wherein said at least one advertising message is disposed on or in one of the group: the label of said first medium, the label of said second medium, embedded in said first medium, embedded in said second medium, on said single package, and on an Internet web site.

14. The single entity for providing advertising relating to the purchase of commercial products in accordance with claim 12, wherein a prize is granted for winning said at least one contest, said prize being chosen from the group: car, recreational vehicle, cash, stock, product, meal, recording deal, travel, jewelry, hotel reservation, special event, movie deal, and any other item or deal.

15. The single entity for providing advertisement relating to the purchase of commercial products in accordance with claim 9, whereas said commercial products are combined or bundled.

16. A method for acquiring and distributing entertainment content and information representative of monetary funds in a single package, the steps comprising:
a) acquiring entertainment content;
b) acquiring information representative of monetary funds; and
c) selling said entertainment content and said information representative of monetary funds as a single package.

17. The method for acquiring and distributing entertainment content and information representative of monetary funds in a single package in accordance with claim 16, the steps further comprising:
d) conducting at least one contest for a customer based on information residing on said medium.

18. The method for acquiring and distributing entertainment content and information representative of monetary funds in a single package in accordance with claim 17, wherein said at least one contest is conducted by using the Internet.

19. The method for acquiring and distributing entertainment content and information representative of monetary funds in a single package in accordance with claim 16, wherein said selling said entertainment content and said information representative of monetary funds as a single package step (c) is accomplished by means of the Internet.

20. The method for acquiring and distributing entertainment content and information representative of monetary funds in a single package in accordance with claim 16, whereas said entertainment content and information representative of said monetary funds are combined or bundled.

21. A single package for providing information representative of monetary funds and commercial products comprising:
a) commercial products; and
b) a medium for holding information representative of monetary funds.

22. The single package for providing information representative of monetary funds and commercial products in accordance with claim 21, further comprising:
c) means for conducting at least one contest based on information residing on said single package.

23. The single package for providing information representative of monetary funds and commercial products in accordance with claim 21, whereas said information representative of monetary funds and said commercial products are combined or bundled.

24. A single package for providing first entertainment content and second entertainment content comprising:
a) a first medium for holding first entertainment content; and
b) a second medium for holding second entertainment content.

25. The single package for providing first entertainment content and second entertainment content in accordance with claim 24, further comprising:
c) means for conducting at least one contest based on information residing on said single package.

26. A single package for providing first monetary funds and second monetary funds comprising:
a) a first medium for holding first monetary funds; and
b) a second medium for holding second monetary funds.

27. The single package for providing first monetary funds and second monetary funds in accordance with claim 26, further comprising:
c) means for conducting at least one contest based on information residing on said single package.

28. The single package for providing first monetary funds and second monetary funds in accordance with claim 26, whereas said first medium and said second medium are combined or bundled.

29. A system for allowing a customer to purchase a commercial product, a medium having information representative of monetary value, or a download at a participating retail establishment for redemption via the Internet, comprising:
at least one participating retail establishment;
means for indicating a code; and
an Internet accessible database comprising a plurality of goods and services that can be acquired by a customer.

30. The system for allowing a customer to purchase a commercial product, a medium having information representative of monetary value, or a download at a participating retail establishment for redemption via the Internet in accordance with claim 29, further comprising:
means for conducting a contest based on said code.
